(19) United States
(12) Patent Application Publication
(10) Pub. No.: US 2026/0311443 A1
(43) Pub. Date: Oct. 8, 2026

(54) SYSTEM AND METHOD FOR ENHANCED PHYSICAL INTERACTION WITH VIRTUAL ENVIRONMENTS THROUGH PATTERN RECOGNITION AND FEEDBACK MECHANISMS

(71) Applicant: Brent Hubbard BURGESS, Hampshire (GB)

(72) Inventor: Brent Hubbard BURGESS, Hampshire (GB)

(21) Appl. No.: 19/714,332

(22) Filed: Jun. 19, 2026

Related U.S. Application Data
(62) Division of application No. 18/804,972, filed on Aug. 14, 2024, now Pat. No. 12,682,588.
(60) Provisional application No. 63/532,818, filed on Aug. 15, 2023.

(51) Int. Cl. G06T 19/20; G06F 3/01; G06T 19/00

(52) U.S. Cl. CPC G06T 19/20; G06F 3/016; G06F 3/017; G06T 19/006; G06T 2219/2004

(57) ABSTRACT

In some implementations, a computer-implemented method for pattern-based user interaction in virtual environments comprises: recognizing, from image data captured by an image sensor, a registered printed image carried by a physical surface, the registered printed image having predefined interaction areas mapped onto respective user input commands; detecting a localized occlusion of one of the predefined interaction areas caused by a user blocking a view of the one of the predefined interaction areas from the image sensor; generating a user input command mapped to the one of the predefined interaction areas based on the localized occlusion; and causing in response to the user input command, the generation and transmission of a response to a target user interface, application, or physical device that is separate from the physical surface and is not displayed as an augmented reality overlay anchored to the printed image.

### CROSS-REFERENCE TO RELATED APPLICATIONS

This application is a divisional patent application of the U.S. patent application Ser. No. 18/804,972, which claims benefit of U.S. Provisional Patent Application No, 63/532,818, filed Aug. 15, 2023, which is herein incorporated by reference.

### FIELD OF DISCLOSURE

The present disclosure relates to computer-implemented methods for enhancing user interaction within artificial, virtual, and mixed-reality environments through pattern recognition and management and the application of virtual volumes to physical objects and surfaces.

### BACKGROUND

The current interfaces in simulated environments often lack integration with tangible elements, leading to a disconnect between the digital and tangible worlds. This disconnect limits the depth of engagement and the overall experience within artificial environments. Users are generally limited to indirect interaction methods via traditional input devices, which may not fully replicate the experience of interacting with physically present elements. The absence of direct physical interaction can reduce the sense of presence and immersion, as users primarily rely on visual and auditory cues, with tactile feedback lacking.

Attempts to enhance the interaction between the real and simulated worlds have included using object and surface recognition of tangible objects and analyzing these objects to generate corresponding digital representations or planes within simulated environments. Additional equipment has been employed to provide sensory feedback beyond the visual domain, strengthening the connection to the tangible world during digital interactions.

Despite these efforts, there remains an ongoing need for more integrated and interactive methods and systems to provide a richer, more tactile experience in simulated spaces, potentially improving the user's sense of presence and engagement.

Furthermore, current systems for integrating the tangible world with virtual environments lack a physical method to affix virtual objects, displays, and user interfaces to specific physical objects or surfaces. This creates a lack of persistence of a physical location that can be used to create experiences or components in a predictable physical location by a physical object and accessed by any number of individuals, irrespective of a system's knowledge of a specific environment.

### SUMMARY

The claims may serve as a summary of the disclosure.

### BRIEF DESCRIPTION OF THE DRAWINGS

FIG. 1A depicts a block diagram of the system with various pattern inputs.

FIG. 1B displays examples of various pattern types used for system recognition.

FIG. 2 is a block diagram illustrating the pattern recognition and interaction process within a mixed-reality environment.

FIG. 3A illustrates pattern applications on a physical object resembling a book cover.

FIG. 3B illustrates the interaction between a user and a patterned object within a physical world and the corresponding virtual representation in a virtual world.

FIG. 4 illustrates a block diagram depicting various scanning methods for pattern recognition.

FIG. 5A is a flow chart depicting an example process.

FIG. 5B is a flow chart depicting an example process.

FIG. 6 is a block diagram depicting an example computer system on which embodiments may be implemented.

FIG. 7A is an example panel view showing a user wearing AR-enabled glasses with a camera and display-capable lenses.

FIG. 7B is an example panel touch showing an example user interaction with an image.

FIG. 7C is an example of a panel-touch HUD that displays additional information in a user interface.

FIG. 7D is an example of a plaque view that displays plaque information in a user interface.

FIG. 7E is an example of a plaque-touch HUD that displays plaque information in a user interface.

FIG. 8 is an example of a plaque touch HUD.

FIG. 9A is an example of a poster view.

FIG. 9B is an example of a poster touch.

FIG. 10 is an example of a poster touch HUD.

FIG. 11 is a flow chart depicting an example process for pattern-based user interaction in virtual environments.

All the drawings, descriptions, and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

### DESCRIPTION OF EXAMPLE EMBODIMENTS

In the following description, numerous specific details are provided to provide a thorough understanding of the present approach. It will be apparent, however, that the present approach may be practiced without these specific details. In other instances, well-known structures and devices are shown in block diagram form to avoid unnecessarily obscuring the present approach.

Embodiments are described herein according to the following outline:
1.0.GENERAL OVERVIEW
   1.1.TECHNICAL PROBLEM—TECHNICAL SOLUTION
   1.2.TECHNICAL EFFECTS
   1.3.TERM DEFINITIONS
2.0.EXAMPLE BLOCK DIAGRAM OF A SYSTEM WITH VARIOUS PATTERN INPUTS
3.0.EXAMPLES OF VARIOUS PATTERN TYPES USED FOR RECOGNITION
4.0.EXAMPLES OF DIFFERENT EMBODIMENTS
5.0.ADDITIONAL DIFFERENT EMBODIMENTS
6.0.EXAMPLE PATTERN RECOGNITION PROCESS
7.0.EXAMPLES OF PATTERN APPLICATIONS
8.0. SCANNING METHODS
9.0.EXAMPLE FLOW CHARTS
10.0. IMPLEMENTATION MECHANISMS
11.0. SYSTEMS AND METHODS FOR PATTERN-BASED USER INTERACTION IN VIRTUAL ENVIRONMENTS
   11.1. BACKGROUND
   11.2. OVERVIEW
   11.3. TECHNICAL PROBLEM
   11.4. TECHNICAL SOLUTION
   11.5. NOVEL ASPECTS
   11.6. DECOUPLING INTERACTION METHODS FROM VIRTUAL MANIFESTATIONS
   11.7. SYSTEM WITH A CAMERA AND KNOWLEDGE OF IMAGES
   11.8. PRINTING POSTERS, PANELS, OR PLAQUES
   11.9. SUB-AREAS OF PATTERNS AND IMAGES
   11.10. GENERATING USER INPUT COMMANDS
   11.11. AI-BASED EXAMPLE IMPLEMENTATIONS
   11.12. EXAMPLE METHOD
      11.12.1. EXAMPLE FLOW
      11.12.2. EXAMPLE FLOWCHART
   11.13. EXAMPLE SYSTEM
   11.14. BENEFITS OF THE PRESENT APPROACH

### 1.0. GENERAL OVERVIEW

One aspect of the present approach is a method to enhance user interaction in a virtual environment by linking physical objects to their virtual counterparts. The method comprises a physical object having a surface with a pattern thereon. Furthermore, the method includes capturing, by a scanning device, an image of the pattern on the surface of the physical object; analyzing, by a computer system, the captured image to recognize the pattern and associate the pattern with corresponding virtual content stored in a data storage; and rendering, by the computer system, a virtual manifestation within the virtual environment. The virtual manifestation corresponds to the physical object based on the recognized pattern. It is displayed in a relative position to the user that mirrors the physical object's position in the real world.

The method further comprises detecting, by the scanning device, the occlusion of the pattern caused by user interaction with the physical object; interpreting, by the computer system, the occlusion as a user input command for the virtual environment; modifying, by the computer system, the virtual manifestation in response to the user input command; and activating, by the computer system, one or more peripheral devices to generate non-visual physical stimuli corresponding to the virtual manifestation and the user interaction. The non-visual physical stimuli selected from the group consist of haptic feedback, heat, and scent to enhance the user's sensory experience.

The method further comprises updating, by the computer system, the virtual manifestation in real-time to reflect movements of the physical object captured by the scanning device, thereby maintaining the correspondence between the physical object and the virtual manifestation as the user interacts with the physical object.

In another aspect, the physical object resembles a book, with a surface resembling a cover and one or more interior surfaces on which a pattern or patterns are printed.

According to yet another aspect, the pattern comprises a QR code that encodes location and physical attribute information, information related to the content of the virtual manifestation, and/or information related to a user.

According to another aspect, the scanning device is a camera integrated into a head-mounted display that displays the virtual environment.

In another aspect, the computer system analyzes the captured image using a machine-learning algorithm trained to recognize and distinguish among a plurality of patterns.

In another aspect, the virtual manifestation is a three-dimensional model rendered to appear as a continuation of the physical object within the virtual environment.

In another aspect, detecting pattern occlusion involves recognizing a user-made hand gesture that corresponds to a command within the virtual environment.

Another aspect of the computer system's peripheral devices includes a haptic feedback device configured to simulate the texture and resistance of turning pages in a book.

Another aspect is that the non-visual physical stimuli include a scent diffuser activated to release scents thematically related to the content being interacted with in the virtual environment.

In some implementations, an apparatus for enhancing user interaction within a virtual environment by providing a physical connection to virtual manifestations comprises a physical object having a surface on which a pattern is disposed. The pattern is configured to be recognized by a computer system; a scanning device is configured to capture the pattern on the surface of the physical object and to generate input data based on the captured pattern; a computer system is communicatively coupled to the scanning device, wherein the computer system includes a processor and a memory storing instructions that, when executed by the processor, cause the computer system to analyze the input data to recognize the pattern; generate a virtual manifestation within a virtual environment corresponding to the recognized pattern, wherein the virtual manifestation is linked to the physical object and is rendered in a relative position to a user within the virtual environment that corresponds to the position of the physical object in the real world; detect occlusion of the pattern based on user interaction with the physical object and to control elements within the virtual environment based on the detected occlusion; a plurality of peripheral devices configured to provide non-visual physical stimuli to the user, wherein the peripheral devices are controlled by the computer system in response to the user's interaction with the virtual manifestation; wherein the apparatus is configured to operate within an extended reality, virtual reality, or mixed reality platform as an application or as an integrated part thereof, and wherein the virtual manifestation is not restricted to the physical characteristics of the physical object and is capable of displaying any two-dimensional or three-dimensional shape, object, or product of any size.

According to another aspect, the pattern disposed on the physical object's surface comprises geometric shapes, alphanumeric characters, images, or custom-designed symbols recognizable by the computer system.

According to another aspect, the scanning device is an optical camera capable of capturing the pattern in visible light, an infrared sensor for capturing non-visible light, or a depth camera for capturing the pattern's three-dimensional aspects.

In another aspect, the computer system is configured to analyze the input data using a machine-learning algorithm trained to recognize and distinguish among a plurality of patterns.

In another aspect, the virtual manifestation is rendered as an augmented reality overlay superimposed on the user's perception of the real world.

In another aspect, the computer system is configured to detect pattern occlusion by recognizing the user's hand gestures and interpreting them as commands within the virtual environment.

According to another aspect, the plurality of peripheral devices includes at least one haptic feedback device configured to simulate tactile sensations corresponding to interactions with the virtual manifestation.

According to another aspect, the apparatus is compatible with and configured to operate within an extended reality platform provided by a major technology company.

According to another aspect, the virtual manifestation can display any two-dimensional or three-dimensional shape, object, or product of any size. It is further configurable to adapt its display to user preferences or environmental conditions.

Another aspect is that the peripheral devices include a scent diffuser that releases scents thematically related to the content being interacted with in the virtual environment.

In another aspect, the system can display virtual gauges and controls that receive information from sensors, software, or machines used in a wide range of industrial applications.

In another aspect, detecting occlusion of the pattern at a location corresponding to virtual controls can generate commands to move the virtual controls.

In another aspect, changes a user makes to the virtual controls can send information back to sensors, software, or machines to alter or control them.

### 1.1. TECHNICAL PROBLEM-TECHNICAL SOLUTION

Pattern recognition and management play a role in user interaction and virtual environments. In artificial, virtual, and mixed-reality environments, the ability to apply virtual volumes and information to real-world physical objects and surfaces is significant. A challenge persists in the lack of tangible interaction between virtual interfaces or display surfaces and the physical world. Users often interact with virtual spaces using input devices such as keyboards, computer mice, or hand controllers, which lack a direct physical correlation to their virtual counterparts. This disconnect can hinder the immersive experience and limit the potential for natural user interaction within virtual environments.

In mixed or augmented reality environments, where virtual components are overlaid on the real world, many solutions exist for defining where the virtual components should persist. Some solutions include creating a three-dimensional model of an area or environment that is stored and referenced. Virtual components are affixed to physical objects or surfaces in the real world and correspond to the virtual models. These methods rely on software and memory solutions to create a persistent presence of virtual manifestations in physical space. This computer-based reference system for virtual manifestations in the physical world lacks reliable persistence in the physical world. Using a generated virtual reference of physical locations also requires storing and managing potentially complex location and object data that needs to be transferred to each user interacting with the environment. This carries the risk that location and environmental information may be erased, lost, or unavailable in low-power or low-connectivity situations.

Existing solutions in virtual environments primarily rely on visual and contextual cues to create a sense of immersion. While virtual objects and user interface components may appear anchored in a consistent physical location, there is no persistent physical presence or link to the location, and they cannot be touched or physically manipulated. This absence of a physical component that users can interact with in both the virtual and physical worlds results in a diminished connection to the virtual environment. The reliance on traditional computing or gaming input devices further exacerbates this issue, as these tools lack a one-to-one physical correspondence to virtual embodiments, thereby limiting the depth of user engagement and the overall immersive experience.

The present system addresses these challenges by establishing a robust link between the real and virtual worlds. This is achieved through patterns applied to physical objects, surfaces, or surfaces a computer system recognizes. The system includes software that analyzes inputs for these patterns and creates virtual manifestations within virtual environments that correspond to the physical entities. Additionally, the system employs apparatus or machines that generate non-visual physical stimuli, enhancing the connection to the physical world during interactions with virtual environments. The system facilitates a more immersive, persistent, and interactive experience by allowing users to interact with virtual embodiments through physical manipulation of corresponding real-world objects, augmented with non-visual cues that provide a tangible connection in the virtual world.

### 1.2. TECHNICAL EFFECTS

By providing a physical object with a pattern and capturing its image, the method enables the creation of a virtual manifestation directly linked to the physical object. This linkage enables a more intuitive and immersive interaction within the virtual environment, as users can engage with virtual objects or surfaces that correspond to tangible items they can physically touch and manipulate.

An actual physical presence also allows the system to affect the physical world through virtual embodiments. Controls and switches can be rendered virtually at the location or in the context where they are needed, replacing physical controls and switches. Virtual controls can be customized to a specific user, environment, or situation, mitigating the need for costly new physical hardware or equipment upgrades when equipment becomes obsolete.

Analyzing the captured image to recognize the pattern and associate it with virtual content ensures that the virtual manifestation is accurately positioned within the virtual environment to mirror the physical object's position in the real world. This mirroring enhances the user's spatial awareness and seamlessly integrates virtual and physical spaces.

Detecting pattern occlusion caused by user interaction and interpreting it as a user input command enables a natural, direct method for controlling the virtual environment. This interaction paradigm leverages users' familiarity with manipulating physical objects, thereby reducing the learning curve for interacting with virtual environments and increasing accessibility.

The modification of the virtual manifestation in response to user input commands provides a dynamic and responsive virtual experience, where changes in the virtual environment reflect the user's physical actions in real time, further enhancing the sense of presence within the virtual space.

Activating peripheral devices to generate non-visual physical stimuli, such as haptic feedback, heat, or scent, in correspondence with the virtual manifestation and user interaction enriches the user's multisensory experience. This multisensory stimulation is designed to augment the realism of the virtual environment, making the virtual experiences more engaging and memorable by appealing to multiple senses beyond sight and sound.

### 1.3. TERM DEFINITIONS

Many terms are used throughout the specification. Several such terms are defined below. For example, System 100 refers to the overall framework or architecture that enhances user interaction in a virtual environment by linking physical objects to their virtual counterparts. It includes various components such as physical objects, scanning devices, computer systems, and peripheral devices.

101: Media—represents the source or input of patterns used in the system. It can include images, videos, or other visual content forms containing recognizable patterns.

102: Pattern B—refers to a specific pattern the system generates. This pattern is applied to physical objects or surfaces and is recognized by the computer system to create corresponding virtual manifestations within the virtual environment.

103: Pattern C-represents another specific pattern generated by a user. Similar to Pattern B, this pattern is applied to physical objects or surfaces and is recognized by the computer system to create virtual manifestations based on the user's input or customization.

104: Patterns-refers to any computer-discernable arrangement of data that can be applied to physical objects by various means or contained in data from a computer file or detected in input from any method of scanning device.

### 2.0. EXAMPLE BLOCK DIAGRAM OF A SYSTEM WITH VARIOUS PATTERN INPUTS

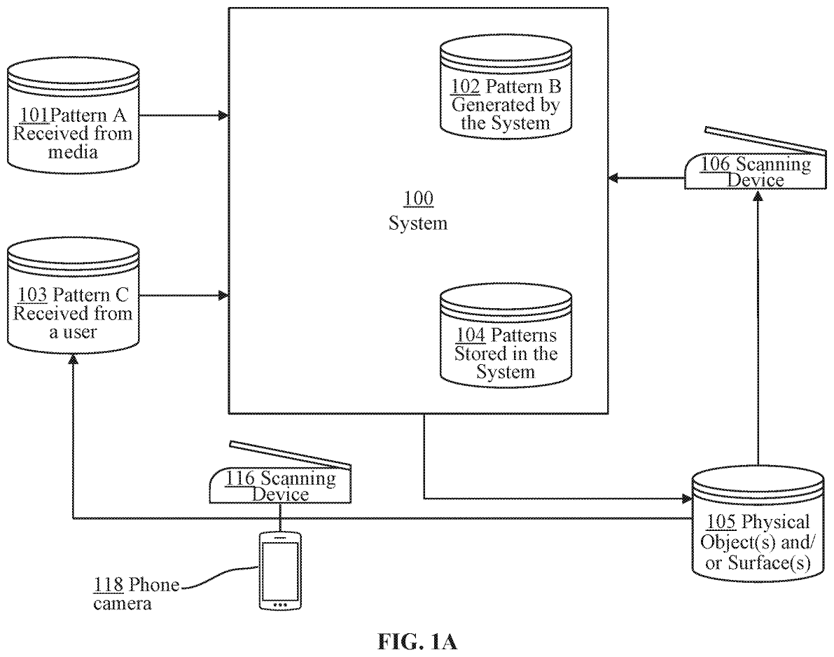

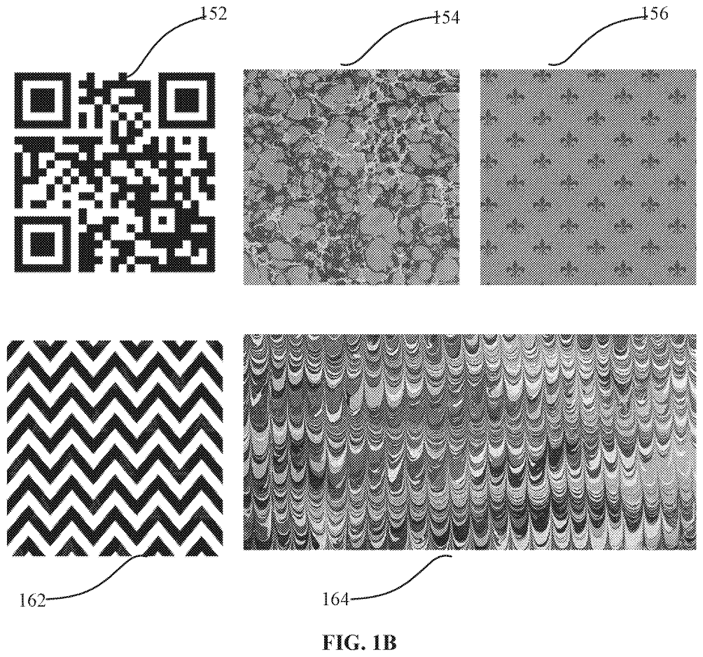

FIG. 1A depicts a block diagram of the system with various pattern inputs. FIG. 1A shows System 100 in communication with Pattern A from Media 101 and Pattern C generated by a user 103. System 100 is configured to create Pattern B 102. The interaction between System 100 and Pattern A from Media 101 involves receiving Pattern A-specific data or inputs from Media 101. Similarly, System 100 receives inputs from Pattern C generated by a user 103, which may include user-specific data or user-generated content.

System 100 processes the inputs received from both Pattern A from Media 101 and Pattern C generated by user 103 to generate Pattern B 102. The generation of Pattern B 102 by System 100 signifies the system's capability to synthesize or transform the received inputs into a new pattern or output. The relationship between the components indicates that System 100 is a central processing unit that integrates different patterns or data sources to produce a resultant pattern.

The significance of this configuration lies in the system's ability to interface with both media-derived and user-generated patterns, suggesting its versatility in fields that require pattern recognition, synthesis, or customization. The depiction of the interactions in FIG. 1A provides a foundational understanding of the roles and capabilities of System 100 in relation to external patterns or inputs. For example, System 100 may apply patterns 104 stored in the system onto physical objects or surfaces 105 stored outside the system. The physical objects or surfaces, covered with patterns or not, may be scanned by, for example, a scanning device 106, and the scanned objects or images may be ported to system 100. In another example, physical objects or surfaces, covered with patterns or not, may be scanned by a scanning device 116 or a phone camera 118, and a user may use the scanned objects or images to generate patterns, such as pattern C 103.

System 100 is the central unit of the approach, orchestrating interactions among various patterns and user inputs. Its pivotal role is to process and analyze patterns received, for example, from Media 101, as well as those generated by the system itself and by the user. System 100 integrates these patterns to facilitate a specific operation or set of operations, which may include, but are not limited to, pattern recognition, pattern generation, and user interaction. System 100 may comprise a processor, memory, and communication interfaces to perform the designated functions.

### 3.0. EXAMPLES OF VARIOUS PATTERN TYPES USED FOR RECOGNITION

FIG. 1B displays examples of various pattern types used for system recognition. FIG. 1B shows PATTERN A 152, PATTERN B 154, PATTERN C 156, PATTERN D 162, and PATTERN E 164. PATTERN A 152 comprises a two-dimensional Quick Response (QR) code, a matrix barcode that stores information for retrieval by a scanning device. PATTERN B 154, PATTERN C 156, PATTERN D 162, and PATTERN E 164 display complex image-based designs, which may serve as reference points for pattern recognition by a computer system.

PATTERN A 152, as a QR code, is designed to encode data that a scanning device can capture and a computer system can process, linking physical objects to virtual manifestations within a virtual environment. The encoded data may relate to the virtual content corresponding to the physical object on which PATTERN A 152 is displayed.

PATTERNS 154/156/162/164, while differing in visual design, both function as recognizable patterns that a computer system can use to connect a physical object and the object's virtual counterpart. These patterns may be applied to the surfaces of physical objects, such as books, tabletops, and other tangible items, to facilitate rendering their virtual manifestations within a virtual environment.

The significance of PATTERN B 154 and PATTERN C 156 lies in their complexity and uniqueness, which allows for precise pattern recognition and differentiation by a computer system. This precision is essential to ensure that the virtual manifestations in the virtual environment accurately correspond to the physical object, enhancing the user's interaction and experience.

Overall, FIG. 1B illustrates patterns essential to the method and apparatus for enhancing user interaction within a virtual environment by providing a physical connection to virtual manifestations. These patterns enable the capture, recognition, and association of physical objects with virtual content, facilitating a more immersive and tactile experience in virtual, augmented, or mixed-reality environments.

Referring to both FIG. 1A-1B, Pattern A from Media 101 represents a predefined design or sequence that serves as a reference or starting point within the system 100. Media 101 may include a variety of forms, such as digital files, printed materials, or physical objects that embody Pattern A. The role of Pattern A from Media 101 is to provide a baseline for comparison or integration with other patterns within the system 100. Media 101 may be introduced into system 100 via scanning devices, user input, or network communication protocols.

Pattern B generated by the system 102 is a derivative pattern created by system 100 based on Pattern A from Media 101 or other inputs. The generation of Pattern B by the system 102 involves computational processes that may include transformation, combination, or enhancement of the initial Pattern A. System 100 utilizes various algorithms and processing techniques to produce Pattern B, which may serve a specific purpose such as user authentication, object identification, or interactive feedback within the system's operational context.

Pattern C, generated by user 103, is a user-created pattern that interacts with system 100. User inputs that result in the creation of Pattern C may come from a variety of sources, such as touch interfaces, voice commands, or motion detection systems. Pattern C, generated by user 103, enables personalization and user-specific responses from system 100. The interaction between Pattern C and system 100 can lead to a multitude of outcomes, including customizing system operations, initiating user-defined processes, or modifying existing patterns within the system.

### 4.0. EXAMPLES OF DIFFERENT EMBODIMENTS

In some implementations, a physical object could be an innovative coffee table with an integrated surface pattern that, when scanned by a specialized camera, triggers the appearance of a virtual coffee cup on a user's augmented reality (AR) headset. The virtual coffee cup would be rendered at the exact location of the pattern, allowing the user to reach out and “feel” the cup via haptic feedback devices embedded in the table's surface. This embodiment provides a seamless blend of physical and virtual interaction, enhancing the user's sensory experience within the virtual environment.

Another embodiment might involve a children's educational toy, such as a puzzle with pieces that have unique patterns. When a piece is placed correctly, a scanning device recognizes the pattern. It communicates with a computer system to display an animated character or story element on a nearby screen or within a mixed-reality headset. This embodiment entertains and educates by providing immediate virtual feedback on physical actions, reinforcing learning through interactive play.

A further embodiment could be a fitness apparatus, like a yoga mat with printed patterns corresponding to different poses. As the user performs yoga on the mat, a scanning device captures the pattern closest to the user's current position and relays it to a computer system. The system then projects a virtual instructor into the user's AR glasses to guide them through the correct pose, adjusting the virtual guidance in real time based on the user's alignment with the patterns on the mat. This embodiment offers a personalized and immersive fitness experience that combines the benefits of a physical workout with the guidance of a virtual instructor.

In another embodiment, the physical object could be a musician's instrument, such as a guitar with a patterned fretboard. As the musician plays, a scanning device detects the patterns where the fingers are placed, and the computer system generates a virtual visualization of the music being played, such as notes or tablature, in the musician's field of view through AR glasses. This embodiment provides an innovative way for musicians to learn and visualize music in real time, enhancing the process of mastering an instrument.

Each of these implementations demonstrates the approach's versatility in providing a tangible connection between physical objects and their virtual counterparts, thereby enriching user interaction within virtual environments across various applications.

### 5.0. ADDITIONAL DIFFERENT EMBODIMENTS

In some implementations, the system is constructed from various materials that offer different levels of durability, weight, and cost-effectiveness. For instance, system components could be made from high-strength alloys for applications requiring robustness or lightweight composites where weight savings are critical. Another embodiment might feature modular design elements, allowing for easy replacement or upgrading of individual components without overhauling the entire system. This modularity could extend to include interchangeable parts that cater to different performance specifications or environmental conditions.

For example, panels with printed patterns can be used for command-and-control interfaces instead of costly control systems. In place of traditional analog or digital dials and switches in industrial settings, patterned panels can be installed at fixed locations, with virtual controls for interaction. These controls can be adapted to individual users with specific duties, arranged or edited to suit a particular user's preferences, or, over time, changed in the virtual world to reflect evolving needs for controlling new or upgraded machines and systems in the physical world.

Furthermore, an embodiment could incorporate advanced control mechanisms, ranging from manual controls to fully automated, AI-driven systems that adjust the system's operation based on real-time data inputs. The system could also be scaled to suit various operational contexts, from compact versions for confined spaces to larger configurations for industrial-scale applications. Additionally, the system might offer multiple configurations of its components to optimize functionality for specific tasks, such as altering the layout or orientation of certain parts to handle different types of workloads better or to integrate seamlessly with existing equipment or processes.

In terms of operational methods, an embodiment could be designed to operate under a range of power-supply conditions, from no-or low-power modes that conserve energy to high-performance modes that maximize output. The system could also be equipped with various sensors and feedback mechanisms to monitor its performance and provide diagnostics or predictive maintenance alerts, thereby enhancing reliability and longevity. While distinct in their specific features and applications, each of these embodiments would maintain the core functionality and adaptability outlined in the system's design.

### 6.0. EXAMPLE PATTERN RECOGNITION PROCESS

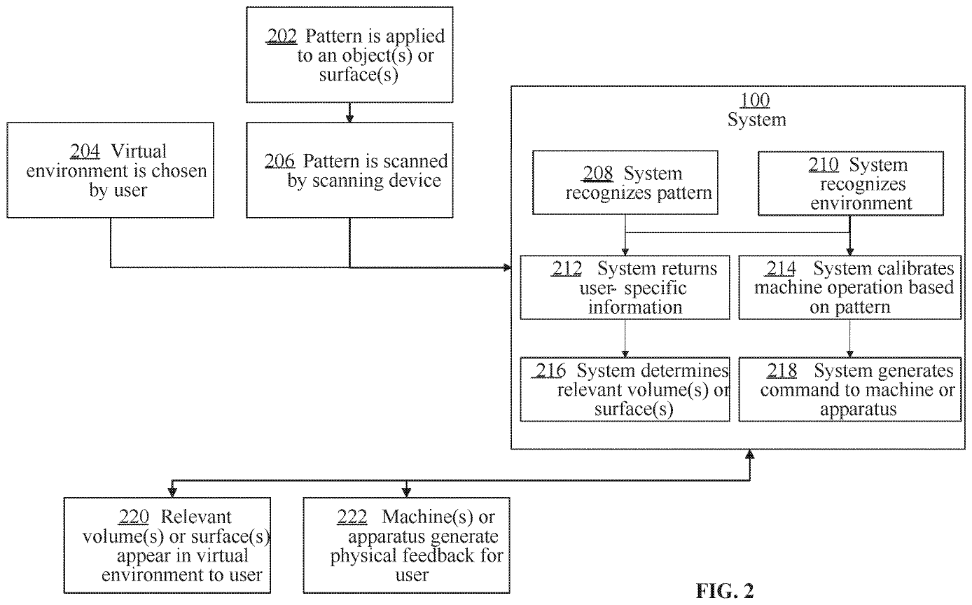

FIG. 2 is a block diagram illustrating the pattern recognition and interaction process within a mixed-reality environment. FIG. 2 shows System 100, where a pattern is applied to an object or surface 202. A user selects a virtual environment 204, and a scanning device captures the pattern 206.

System 100 then recognizes the pattern 208 and identifies the virtual environment 210. Following this, System 100 returns user-specific information 212 and calibrates machine operation based on the recognized pattern 214. The system determines a relevant volume or surface 216 and generates a command to a machine or apparatus 218. Consequently, the appropriate volume or surface appears in the virtual environment to the user 220, and the machine or apparatus generates physical feedback for the user 222.

In the depicted example, the Pattern is applied to an object(s) or surface(s) 202 and is a foundational element in System 100. This component involves applying a specific pattern, which may include a variety of shapes, symbols, or coded information, to one or more physical objects or surfaces. Pattern 202 can be applied through various methods, such as printing, painting, or affixing a pre-designed label. The choice of pattern and application method depends on the intended use within the system and the nature of the object or surface. Once applied, Pattern 202 interacts with other components of System 100 to facilitate user interaction and system functionality.

“Pattern is scanned by scanning device 206” captures the visual or geometric information of Pattern 202. Scanning device 206 can be a camera, a 3D depth-sensing device, or any other suitable image capture technology capable of accurately detecting the applied pattern on the object or surface. The scanning process involves converting the physical pattern into digital data that System 100 can process. Scanning device 206 ensures high-fidelity pattern capture, enabling precise recognition and subsequent system actions.

“System recognizes pattern 208” is a component that analyzes and identifies the scanned pattern data using System 100. This component employs algorithms and processing techniques to compare the captured data with known patterns or a pattern database to determine the identity of Pattern 202. Recognition of the pattern is necessary for System 100 to understand the user's interaction with the object or surface and to determine the system's appropriate response or action.

“System recognizes environment 210” involves identifying and understanding the virtual environment selected by user 204. This component is responsible for interpreting the context within which Pattern 202 is being used. Recognition of the environment is crucial for calibrating the system's response to the pattern and for providing a coherent and relevant user experience. System 100 utilizes data regarding the virtual environment to tailor its operations and outputs to match the user's expectations and the environmental context.

“System returns user-specific information 212” is a component that provides personalized data or feedback to the user based on recognized patterns and the environment. This component considers the user's preferences, history, and interactions with System 100 to generate information tailored to the individual. The user-specific information can include instructions, recommendations, or any other relevant data that enhances the user's engagement with the system and the virtual environment.

“System calibrates machine operation based on pattern 214” is a component that adjusts a machine's or apparatus's functioning in response to the recognized pattern. Calibration involves modifying operational parameters such as speed, force, heat, or movement patterns to align with the requirements dictated by Pattern 202. This component ensures that the machine or apparatus operates consistently with the user's interaction with the pattern and the chosen virtual environment.

“System determines relevant volume(s) or surface(s) 216” is a component that identifies the specific areas of interaction between the user, Pattern 202, and the virtual environment. This component assesses the spatial dimensions and locations pertinent to the user's activities and the system's response. Determining the relevant volumes or surfaces is essential for accurate system operation, as this component directs the focus of both virtual and physical responses to the areas of interest.

“System generates a command to machine or apparatus 218” is a component that translates the system's recognition and calibration processes into actionable instructions for a machine or apparatus. This component bridges the digital and physical aspects of System 100, converting data and decisions made within the virtual environment into real-world mechanical or electronic actions. The commands generated by this component direct the machine or apparatus to perform specific tasks that correspond to the user's interaction with the pattern and the virtual environment.

“Relevant volume(s) or surface(s) that appear in a virtual environment to user 220” is a component that visually represents the determined relevant volumes or surfaces within the virtual environment. This visual representation allows the user to perceive and understand the areas of interaction and focus within the virtual space. The appearance of these volumes or surfaces in the virtual environment aids the user in navigating and interacting with the system, clearly indicating where actions will occur or feedback will be received.

“Machine(s) or apparatus generate physical feedback for user 222” is a component that creates tangible responses or sensations for the user based on the system's operations. This feedback can take various forms, such as haptic vibrations, resistance, or motion, and is designed to enhance the user's sensory experience within the virtual environment. The physical feedback is synchronized with virtual actions and user interactions, providing a cohesive, immersive experience that bridges the gap between the digital and physical realms.

A server (not shown) may be a component that provides centralized processing and data management capabilities for System 100. The server may host databases, manage user sessions, and perform complex computations the system requires. This component is often responsible for the heavy lifting of data processing, enabling efficient system operation and timely responses to user interactions. The server communicates with other components of System 100 to coordinate system-wide activities and ensure seamless user experiences.

### 7.0. EXAMPLES OF PATTERN APPLICATIONS

Referring again to FIG. 1A-1B, the system 100 integrates various components to facilitate the interaction between physical patterns and a virtual environment. System 100 includes Pattern A from Media 101, Pattern B generated by system 102, and Pattern C generated by a user 103. Pattern A from Media 101 is a predefined reference that System 100 utilizes to recognize and interpret physical patterns. Pattern B, generated by system 102, represents a machine-generated counterpart to Pattern A, which system 100 uses to compare and analyze patterns within the operational context. Pattern C, generated by user 103, reflects user-created or user-modified patterns that system 100 processes to personalize the user's experience within the virtual environment.

Patterns A 101, B 102, and C 103 are essential to the system's ability to differentiate and process various patterns. Pattern A 101, originating from Media 101, provides a baseline for the system 100 to identify and calibrate responses. Pattern B 102, as generated by system 102, enables dynamic interaction and adaptation to the user's inputs or environmental changes. Pattern C 103, generated by user 103, introduces a level of customization and personalization, enabling system 100 to cater to individual user preferences and requirements.

The system 100 applies Pattern A 101, Pattern B 102, and Pattern C 103 to an object(s) or surface(s) 202 within a chosen virtual environment 204. The scanning device 206 scans the applied patterns, and the system 100 recognizes the pattern 208 and the environment 210. Based on this recognition, the system 100 returns user-specific information 212 and calibrates machine operation based on the pattern 214. The system 100 determines relevant volume(s) or surface(s) 216 and generates commands to a machine or apparatus 218. The relevant volume(s) or surface(s) 220 appear in the virtual environment to the user, and the machine(s) or apparatus 222 generate physical feedback for the user.

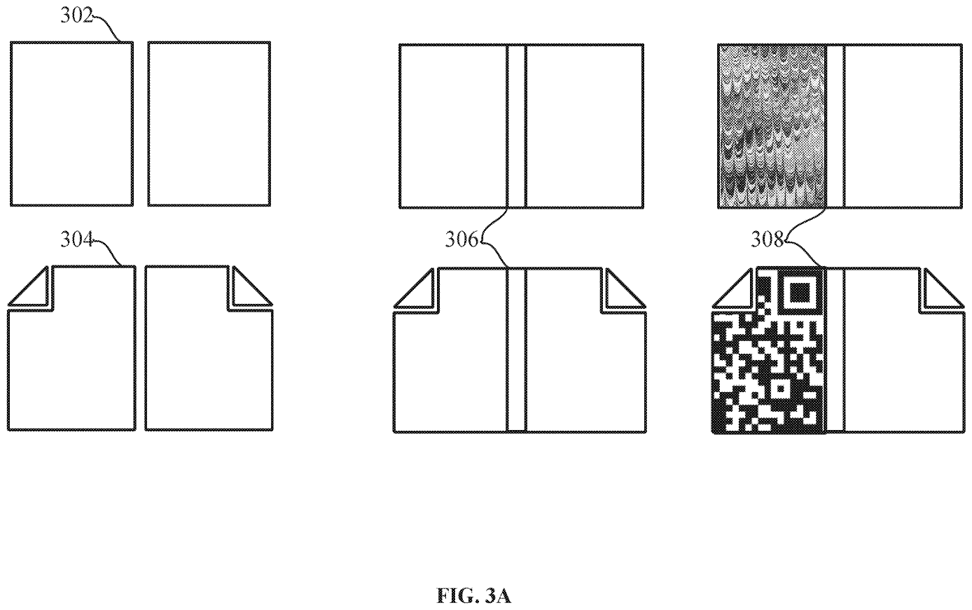

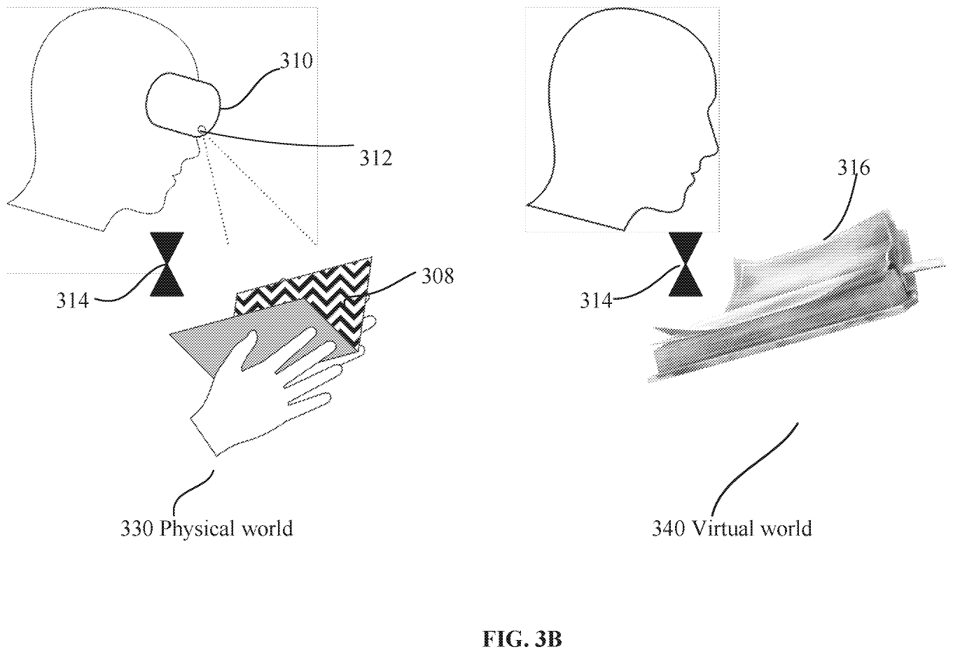

FIG. 3A illustrates the application of patterns on a physical object resembling a book cover. FIG. 3A illustrates the construction of a book form factor, displaying the physical characteristics of a book 302 with a cover and interior pages 304. This figure provides a visual representation of how the physical object, in this case, book 306, can be designed to resemble a traditional book with recognizable features such as a cover and pages. The pattern is printed on the interior surface of page 308, allowing for pattern recognition and interaction within the virtual environment. This embodiment demonstrates the approach's applicability to a book-like object, highlighting the potential for enhanced user interaction and immersion in virtual environments.

FIG. 3B illustrates the interaction between a user and a patterned object within a physical world and the corresponding virtual representation in a virtual world. FIG. 3B shows a side-by-side comparison of elements in both the physical and virtual worlds. On the left side, representing the physical world, a wearable headset 310 is depicted with a camera 312. Camera 312 is oriented toward a physical object 314 that displays patterns 308 on its surface. A user's hand is shown interacting with the physical object 314, suggesting that the camera 312 captures patterns 308.

On the right side, representing the virtual world, physical object 314 is shown again, but this time as a virtual representation of the physical object 316. The virtual representation 316 reflects the interaction occurring in the physical world, as indicated by the alignment of the physical object 314 in both the physical and virtual depictions. This alignment demonstrates the system's capability to mirror the position and orientation of the physical object 314 within the virtual environment, maintaining a consistent and corresponding virtual representation 316.

The figure illustrates the system's ability to bridge the gap between the physical and virtual worlds by capturing real-world interactions and translating them into the virtual environment. Camera 312 plays a role in this process by capturing patterns 308, which the system uses to recognize and render the virtual representation 316. The user's interaction with physical object 314, as captured by camera 312, is important to the system's functionality, enabling real-time updates to virtual representation 316 in response to the user's actions.

Wearable headset 310, equipped with camera 312, allows the user to interact with the virtual environment and physical object 314. Patterns 308, when recognized by system 100, facilitate the creation of a virtual representation of physical object 316, enhancing the user's immersive experience.

### 8.0. SCANNING METHODS

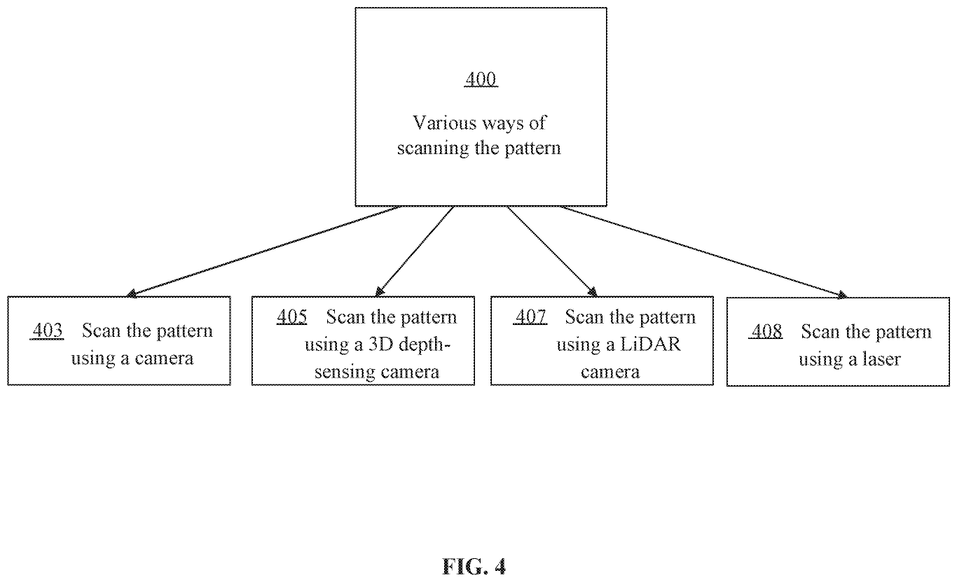

FIG. 4 illustrates a block diagram depicting various scanning methods for pattern recognition. FIG. 4 shows scanning the pattern 400 that encompasses multiple scanning technologies. The figure illustrates the use of various devices to capture the pattern on the surface of a physical object. Each device represents a different scanning method, contributing to the system's ability to recognize patterns and associate them with corresponding virtual content. Multiple scanning methods can be used simultaneously to improve the system's ability to capture and identify patterns.

“Scan the pattern using a camera 403” depicts a standard optical camera that captures images in visible light. This camera serves as a scanning device that can detect patterns on the surface of a physical object. A computer system then analyzes the captured image data to recognize the pattern.

“Scan the pattern using a 3D depth-sensing camera 405” represents a scanning device that captures not only the visual appearance of the pattern but also the pattern's three-dimensional characteristics. This depth information is important for recognizing patterns in physical depth or for applications where the spatial relationship between the pattern and the environment is significant.

“Scan the pattern using a LiDAR camera 407” refers to a scanning device that uses Light Detection and Ranging technology. A LiDAR camera can accurately capture the contours and dimensions of the pattern by measuring the time it takes for light to reflect from the surface. This technology is particularly useful for capturing patterns in a variety of lighting conditions and at different ranges.

“Scan the pattern using a laser 408” indicates the use of a laser scanning device. This device can provide high-resolution pattern capture, which is beneficial for those who require precise measurement and recognition. Laser scanners are often used for their accuracy and the fine detail they can capture in pattern recognition tasks.

Overall, FIG. 4 demonstrates the system's versatility in using different scanning technologies to capture patterns on physical objects. Each scanning method contributes to the system's robustness in recognizing and rendering virtual manifestations within a virtual environment.

“Scanning the pattern 400” involves various technologies to capture the physical patterns accurately. The camera 403, 3D depth-sensing camera 405, LiDAR camera 407, and laser 408 each offer different modalities for scanning the pattern, ensuring that the system 100 accurately captures the details necessary for processing and interaction within the virtual environment.

### 9.0. EXAMPLE FLOW CHARTS

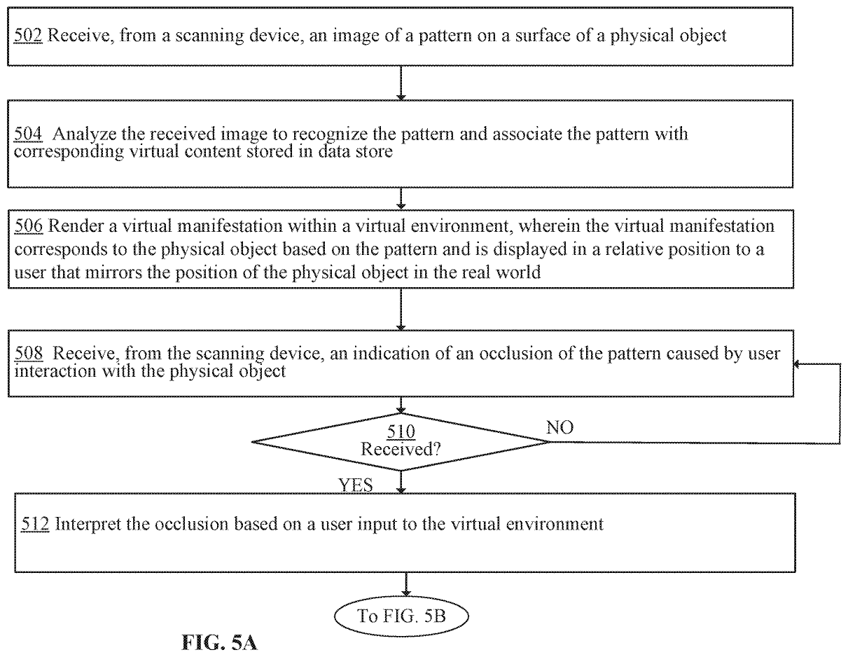

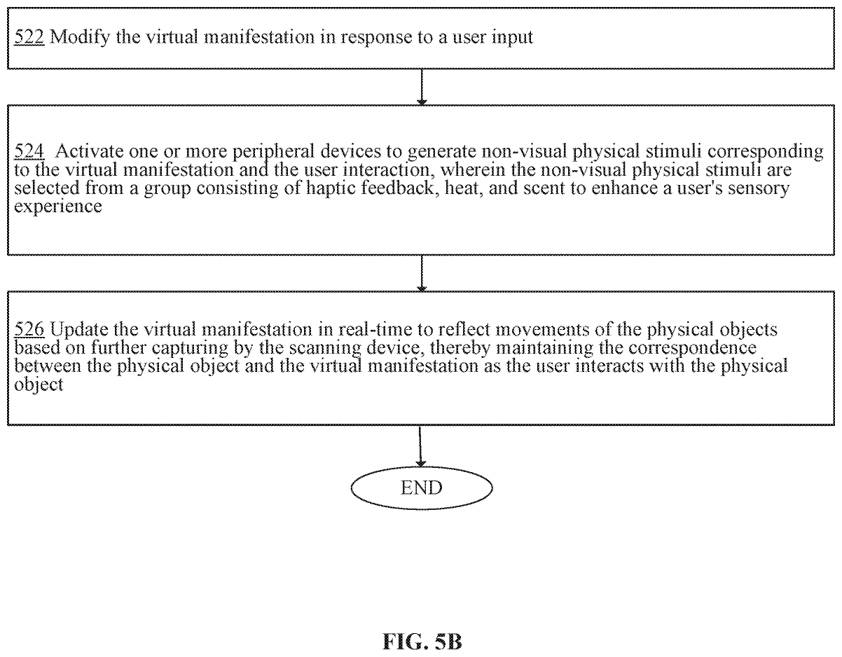

FIG. 5A is a flow chart depicting an example process. More specifically, FIG. 5A depicts example steps in a method for enhancing user interaction in a virtual environment by linking physical objects to their virtual counterparts. The example steps may be executed by a system, such as system 100 depicted in FIG. 1A.

In step 502, a system receives from a scanning device an image of a pattern on the surface of a physical object.

In step 504, the system analyzes the received image to recognize the pattern and associate it with the corresponding virtual content stored in a data storage.

In step 506, the system renders a virtual manifestation within the virtual environment. The virtual manifestation corresponds to the physical object based on the recognized pattern. It is displayed in a relative position to the user that mirrors the physical object's position in the real world.

In step 508, the system receives an indication from the scanning device of a pattern occlusion caused by user interaction with the physical object. If it is confirmed, in step 510, that the indication was received, the system proceeds to step 512. Otherwise, the system waits for the indication.

In step 512, the system interprets the occlusion based on a user input to the virtual environment.

The subsequent steps are described in FIG. 5B.

FIG. 5B is a flow chart depicting an example process. In step 522, the system modifies the virtual manifestation in response to the user input.

In step 524, the system activates one or more peripheral devices to generate non-visual physical stimuli corresponding to the virtual manifestation and the user interaction, wherein the non-visual physical stimuli are selected from a group consisting of haptic feedback, heat, and scent to enhance the user's sensory experience.

In step 526, the system updates the virtual manifestation in real time to reflect the movements of the physical object based on further capture by the scanning device, thereby maintaining the correspondence between the physical object and the virtual manifestation as the user interacts with it.

### 10.0. IMPLEMENTATION MECHANISMS

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wire and/or program logic to implement the techniques.

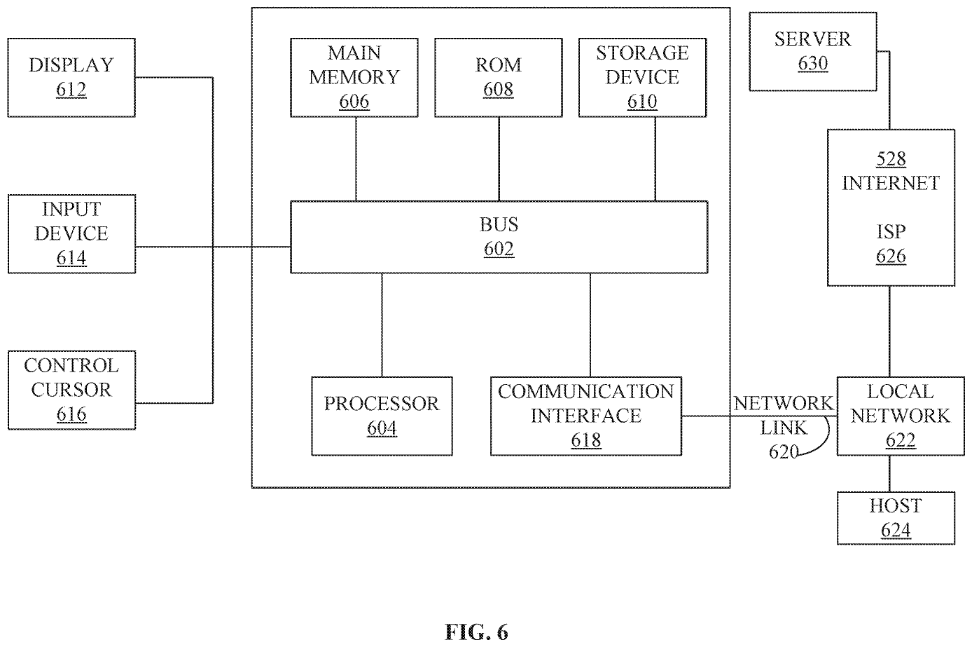

For example, FIG. 6 is a block diagram that illustrates a computer system 600. Computer system 600 includes a bus 602 or other communication mechanism for communicating information, and a hardware processor 604 coupled with bus 602 for processing information. Hardware processor 604 may be, for example, a microprocessor.

Computer system 600 also includes a main memory 606, such as a random-access memory (RAM) or other dynamic storage device, coupled to bus 602 for storing information and instructions to be executed by processor 604. Main memory 606 may also be used to store temporary variables or other intermediate information during execution of instructions by processor 604. Such instructions, when stored in non-transitory storage media accessible to processor 604, render computer system 600 into a special-purpose machine customized to perform the operations specified by the instructions.

Computer system 600 further includes a read-only memory (ROM) 608 or other static storage device coupled to bus 602 for storing static information and instructions for processor 604. A storage device 610, such as a magnetic disk or an optical disk, is provided and coupled to bus 602 to store information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. The input device typically has two degrees of freedom in two axes, a first axis (e.g., x) and a second axis (e.g., y), that allow the device to specify positions in a plane.

Computer system 600 may implement the techniques described herein using customized hard-wired logic, one or more ASICs or FPGAs, and/or firmware and/or program logic, which, in combination with the computer system, cause or program computer system 600 to be a special-purpose machine. According to one embodiment, the techniques herein are performed by computer system 600 in response to processor 604 executing one or more sequences of instructions stored in main memory 606. Such instructions may be read into main memory 606 from another storage medium, such as storage device 610. Execution of the instruction sequences in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media facilitate the transfer of information between storage media. For example, transmission media includes coaxial cables, copper wire and fiber optics, including the wires that comprise bus 602. Transmission media can also take the form of acoustic or light waves, such as those used in radio-wave and infrared data communications.

Various forms of media may be involved in carrying one or more sequences of instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive data over the telephone line and use an infrared transmitter to convert it into an infrared signal. An infrared detector can receive the data carried in the infrared signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication to and from other data devices over one or more networks. For example, network link 620 may provide a connection through local network 622 to a host computer 624 or to data equipment operated by an Internet Service Provider (ISP) 626. ISP 626, in turn, provides data communication services through the worldwide packet data communication network, now commonly referred to as the “Internet” 628. Local network 622 and Internet 628 both use electrical, electromagnetic, or optical signals that carry digital data streams. The signals through the various networks, on network link 620, and through communication interface 618, which carry digital data to and from computer system 600, are examples of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as received and/or stored in storage device 610 or other non-volatile storage for later execution.

### 11. SYSTEMS AND METHODS FOR PATTERN-BASED USER INTERACTION IN VIRTUAL ENVIRONMENTS

### 11.1. BACKGROUND

The current state of augmented reality displays and associated interaction methods lacks reliable, low-power, low-compute, low-latency, and geographically specific techniques that enable users to interact with the real world or to provide input commands for user interfaces presented on hardware display surfaces. Existing approaches are largely confined to hand-tracking and gesture recognition, voice commands processed through cloud-connected virtual assistants, or external hardware interaction devices that trigger events, such as controllers, wristbands, bracelets, or rings. These approaches require sophisticated computational methods, algorithms, and cloud-based systems connected to powerful computer networks, thereby consuming substantial hardware resources and power in devices where effectiveness and efficiency are critical for continuous operation.

In addition, hand gestures, wearable hardware, and virtual assistants used to trigger events in heads-up displays lack a direct system-level connection to physical-world objects or locations. These interaction methods remain within the user's envelope of occupation because they are tied to the user's physical person rather than to a separate object or location in the real world. Binding interaction methods to the user can hinder interaction with the physical world when a user is interacting with virtual environments or controlling virtual user interfaces.

### 11.2. OVERVIEW

The present approach defines interaction paradigms in which a patterned physical surface serves as an input device and a wearable display, such as augmented reality glasses, a head-up display, or smart glasses, serves as an output device. In such implementations, a rendered user interface may be presented on the wearable device's display rather than as a spatial overlay anchored to the patterned surface. This arrangement is particularly applicable to display hardware in which visual output is presented as a screen within a user's field of view rather than as a full spatial augmented reality overlay. Specification support for these hardware elements is strong, including support for a camera integrated into a head-mounted display.

The patterned physical surface may serve as an input device without necessarily presenting a rendered object on the interaction surface. In this arrangement, occlusion of the patterned physical surface functions as the input mechanism. A wearable display, such as augmented reality glasses, a heads-up display, or smart glasses, may serve as the output device. When the user approaches the patterned physical surface, the system recognizes the pattern and renders a user interface on the wearable device's display.

The user interface may respond to occlusion caused by the user's touch input on the surface. In contrast, the rendered user interface is presented on the wearable device's own display rather than as a spatial overlay anchored to the physical surface.

This arrangement may be implemented using display hardware in which visual output is presented on a screen within the user's field of view, rather than as a full spatial augmented-reality overlay.

In some implementations, the inventive focus is on using a recognizable pattern on a physical object or surface as a persistent physical anchor for virtual content, virtual controls, or other virtual manifestations in an augmented, virtual, or mixed-reality environment. Rather than relying solely on a stored spatial map, an environmental model, a controller, a keyboard, a mouse, a touch-sensitive panel, or another separate input device, the system recognizes a pattern captured by a scanning device. It uses that recognition to associate the physical object with the corresponding virtual content displayed at a position that mirrors the object's real-world position.

A further inventive focus is the use of occlusion of the recognized pattern as the input mechanism. The specification describes a user physically touching or otherwise occluding a known pattern or known sub-region of an image, with the computer system interpreting the occlusion as a command to modify or control the virtual manifestation. This creates a physical, location-specific way to interact with virtual user interfaces, such as controls on a panel, plaque, poster, book-like object, or industrial control surface, while maintaining real-time correspondence between the physical object and the virtual manifestation.

### 11.3. TECHNICAL PROBLEM

Augmented reality, virtual reality, mixed reality, and heads-up display systems usually lack a reliable mechanism for generating user input commands that is both physically grounded and efficient for devices with constrained processing, power, and latency budgets. Interaction techniques based on hand tracking, gesture recognition, voice commands, cloud-connected assistants, controllers, wristbands, rings, or other external hardware can involve complex signal processing, continuous tracking, network resources, or additional user-worn components. These requirements can be limited for wearable display devices and other camera-based systems, where compute resources, battery capacity, and response time are at a premium during continuous operation.

Such systems can also lack a direct system-level connection between user input and particular physical objects or physical locations in the real world. When interaction mechanisms are tied primarily to the user's body, voice, or separate controllers, the interaction is not naturally anchored to a panel, plaque, poster, control surface, printed object, or other geographically particular physical element. As a result, virtual interfaces and command inputs can fail to provide a persistent, predictable, and physically meaningful point of interaction that can be accessed at the same real-world location or object by different users or devices.

Further technical difficulties arise when virtual content or user interfaces depend on stored spatial maps, environmental models, or probabilistic interpretation of variable human motions to maintain correspondence between a virtual interface and the physical world. Such approaches can involve storing, transferring, and managing complex location or object data and can be vulnerable when connectivity, power, or stored environmental information is unavailable. Accordingly, a technical need exists for a low-compute, low-power, low-latency, and geographically particular input mechanism that can use camera-based recognition of known physical images or patterns and detection of occlusion of known interaction areas to generate user input commands for virtual or physical systems while avoiding complex hand-tracking, separate input hardware, or cloud-dependent interaction processing.

### 11.4. TECHNICAL SOLUTION

The technical solution provides a computer-implemented interaction system in which a scanning device captures a known image, pattern, or defined sub-area of a physical object or surface, and a computer system analyzes the captured sensor data to recognize the known image or pattern. The recognized image or pattern can be printed or otherwise disposed on a panel, plaque, poster, book-like object, industrial control surface, or another physical surface. It can include QR codes, ArUco markers, icons, geometric features, alphanumeric characters, images, or another computer-discernible arrangement of data. By associating the recognized physical image or pattern with stored information, contextual data, or corresponding virtual content, the system establishes a physically grounded input surface that can be recognized by camera-based hardware without requiring a stored environmental model or a separate user-worn input controller.

The system further detects occlusion of the known image, pattern, or defined interaction area in a camera or sensor feed and interprets the occlusion as a user input command. The occlusion may result from a user touching the physical surface or otherwise blocking the known area from the scanning device's view. In response, the computer system can modify a virtual manifestation, control a user interface displayed on a head-mounted display, heads-up display, AR-enabled glasses, phone, wearable device, or other display device, or send a signal to another virtual or physical system. In this manner, a printed or otherwise recognizable physical surface can operate as a location-specific input device. At the same time, the responsive user interface or system action need not be physically bound to the same surface.

In some implementations, the system renders information, controls, overlays, or other virtual manifestations based on the recognized pattern and updates those manifestations or controls in response to detected occlusion. The system can use user-specific information, location data, contextual data, AI assistant output, encoded pattern data, or stored configuration information to determine which interface or action to provide. It can generate visual, auditory, haptic, heat, scent, vibration, or other feedback to indicate or enhance the interaction. The resulting architecture uses image recognition and occlusion detection as a deterministic input-generation mechanism that can support low-compute, low-power, low-latency, geographically specific interaction with virtual interfaces, non-visual user interfaces, and physical systems.

### 11.5. NOVEL ASPECTS

The approach to pattern-based user interactions in virtual environments presented herein offers several novel features. For example, one novel aspect provides a recognizable physical image, pattern, marker, icon, or defined image sub-area as a persistent physical anchor for virtual content or controls. The uploaded documents describe physical surfaces, such as panels, plaques, posters, books, and industrial control surfaces, that contain known patterns or image regions. When a scanning device, such as a camera associated with AR-enabled glasses, captures and recognizes the known pattern or image, the system associates that physical surface with corresponding virtual content and can render information, overlays, controls, or other virtual manifestations in relation to the recognized physical object.

Another novel aspect provides occlusion of the recognized pattern or known image sub-area as the mechanism for generating user input commands. The uploaded documents describe a user touching an icon, QR code, ArUco marker, or other known location on a physical panel, plaque, or poster, thereby occluding the known area in the visual sensor feed. The system detects the occlusion at the known location. It interprets it as a command to control a user interface, display additional information, select a showtime, purchase tickets, move virtual controls, or otherwise modify a virtual or physical system.

Another novel aspect provides a solution to decouple the physical input surface from conventional input hardware while maintaining a location-specific, repeatable interaction point. The documents emphasize that printed panels, plaques, posters, or other physical surfaces can serve as persistent physical locations for virtual controls accessible to users via AR-enabled glasses or other display devices. This allows a physical object or surface to function as an interaction substrate without requiring separate controllers, keyboards, mice, hand-held devices, or stored environmental models as the primary basis for locating and controlling the virtual interface.

Another novel aspect provides a solution for extending the recognized-pattern interaction framework beyond visual display into adaptive, multisensory, and machine-control contexts. The uploaded documents describe virtual manifestations that may include two-dimensional or three-dimensional content, virtual gauges and controls, user-specific interfaces, and feedback generated through haptic, heat, scent, vibration, or other peripheral devices. The documents also describe commands being sent to machines, apparatuses, sensors, software, or industrial systems, making the approach applicable not only to AR information display but also to control interfaces that can be customized, updated, and physically anchored through recognizable surfaces.

### 11.6. DECOUPLING INTERACTION METHODS FROM VIRTUAL MANIFESTATIONS

Decoupling interaction methods from virtual manifestations in AR/VR systems means separating the mechanism that generates a user input command from the specific virtual object, overlay, interface, or manifestation affected by that command. In some implementations, a camera or other environment imaging system captures a known printed image, pattern, icon, marker, or defined sub-area on a physical poster, panel, plaque, book-like object, or other surface. A computer system recognizes a known image or pattern. It detects occlusion of a defined interaction area, such as when a user touches it or blocks it from the camera's view. The detected occlusion is then used to generate a user input command.

In an attached virtual manifestation arrangement, the recognized pattern and the virtual manifestation may have a direct spatial relationship. For example, the system may display virtual content, controls, gauges, overlays, or three-dimensional content at or near the recognized physical object, and occlusion of the pattern or a sub-area of the pattern may modify the displayed content or control the associated interface. In that arrangement, the physical pattern serves as both a recognition anchor and an interaction surface for a virtual manifestation spatially related to the physical object or surface.

In a decoupled arrangement, the same occlusion-based input mechanism may control a virtual manifestation, user interface, system function, or external device that is part of the same sensor, data, and display system but is not physically bound to the detected image. For example, a user wearing AR glasses may approach a printed panel that is known to the system, and the system may use location data, encoded pattern data, contextual data, or AI-assisted analysis to determine available options. The user may touch a visually marked or verbally identified interaction area on the panel, and the resulting occlusion may cause the system to generate a command that changes a separate user interface, orders an item, turns on a light, controls a machine, or otherwise sends a signal to a virtual or physical system.

Decoupling from “pattern+attached virtual manifestation+occlusion interaction method” to “pattern+detached virtual manifestation/UI+occlusion interaction method” is the next natural layer. However, there is also a “maximum abstraction” step that completely decouples the interaction method from virtual manifestations altogether.

This decoupling allows a physical surface to operate as a low-power, low-compute, low-latency, and geographically specific input substrate without requiring the affected interface or system action to be displayed on, attached to, or spatially co-located with that surface. The approach preserves the deterministic advantages of detecting occlusion of known images or patterns while extending the command output beyond directly anchored virtual manifestations. Accordingly, the interaction method may support AR/VR systems with visual user interfaces, heads-up displays, non-visual user interfaces, voice-assistant-based systems, and physical control systems in which the detected physical interaction generates an input command for a separate virtual or physical response.

### 11.7. SYSTEM WITH A CAMERA AND KNOWLEDGE OF IMAGES

A system with a camera and knowledge of an image, or images, can include a scanning device configured as an optical camera, a camera integrated into a head-mounted display, a camera associated with AR-enabled glasses, a phone camera, a three-dimensional depth-sensing camera, a LiDAR camera, or another image-capture device. The camera captures image data from a physical object or surface that bears a known image, known pattern, marker, icon, geometric feature, alphanumeric character, QR code, ArUco marker, or other computer-discernible arrangement of data. The captured image data is provided to a computer system having a processor and memory storing instructions for analyzing the image data and determining whether the captured image corresponds to one or more images or patterns known to the system.

The system's knowledge of the image or images may be represented by stored pattern data, encoded information, reference images, user-generated patterns, system-generated patterns, media-derived images, or other stored information that enables comparison with the camera-captured image data. The known image may be printed or otherwise disposed on a panel, plaque, poster, book-like object, industrial control surface, tabletop, toy, yoga mat, instrument, or other tangible surface. In some implementations, the image or pattern serves as a reference point that enables the computer system to recognize the particular physical object or surface and associate that recognized object or surface with corresponding virtual content, stored information, user-specific information, contextual data, a selected virtual environment, or a machine-control operation.

After the camera captures the image, the computer system analyzes the captured data to recognize and distinguish the known image or pattern from other images or patterns. The analysis may include comparison of the captured image data against a database or other collection of known patterns. It may use algorithms or a machine-learning algorithm trained to recognize and distinguish among a plurality of patterns. When the image is recognized, the system can render a virtual manifestation, overlay, user interface, virtual gauge, control, two-dimensional content, three-dimensional content, or other virtual element that corresponds to the recognized image or pattern. The rendered virtual element may be displayed at a position that mirrors the physical object's position in the real world or used to provide an interface or system response associated with the known image.

The same camera-based system can also detect when the known image, pattern, or defined sub-area is occluded by user interaction, such as a user touching or blocking the known area on the physical surface. The computer system can interpret the detected occlusion as a user input command and, in response, modify a virtual manifestation, control a displayed user interface, move virtual controls, display additional information, purchase tickets, generate a command to a machine or apparatus, or send information back to sensors, software, machines, or industrial systems. In this manner, the combination of a camera and stored knowledge of one or more images provides a physically grounded, location-specific input mechanism for virtual environments, heads-up displays, non-visual interfaces, and physical control systems.

### 11.8. PRINTING POSTERS, PANELS, OR PLAQUES

A poster, panel, or plaque printed with a pattern or image known to the system may operate as a tangible interaction surface for a camera-based computing system. The poster, panel, or plaque can include movie poster artwork, informational graphics, button imagery, QR codes, ArUco markers, icons, geometric features, alphanumeric characters, custom symbols, or other computer-discernible image content. The printed pattern or image is known to the system because the system stores or otherwise has access to corresponding pattern data, reference image data, encoded data, or information associated with the printed surface. When a user wearing AR-enabled glasses, a head-mounted display, a heads-up display, or another device having an environment imaging system approaches the printed surface, the camera captures the printed image or pattern for recognition by the computer system.

The system analyzes the captured image data to determine whether the poster, panel, or plaque corresponds to a known image or pattern. Recognition may be performed by comparing the captured data to stored patterns, reference images, or a database of known image information, and may include use of algorithms or machine-learning techniques trained to recognize and distinguish among a plurality of patterns. Once the printed surface is recognized, the system can associate the surface with stored information, user-specific information, contextual data, location data, encoded pattern information, or virtual content corresponding to the known image. In some implementations, location specificity can be added using on-device location awareness or an external signal, such as BLE or Wi-Fi, so that the recognized poster, panel, or plaque is interpreted in view of geographical or environmental context.

One or more sub-areas of the printed pattern or image may be defined in the system as interaction areas for occlusion detection. These interaction areas may be visually indicated on the printed surface, such as through “Yes” and “No” button imagery, icons, ArUco markers, or other printed indicia, or may be described to the user by an AI assistant or other system output. When the user touches, covers, or otherwise blocks one of the defined sub-areas from the camera's view, the system detects occlusion of that known sub-area and interprets it as a user input command. Thus, the poster, panel, or plaque can function as a persistent, geographically particular input substrate without requiring a separate controller, keyboard, mouse, touch-sensitive panel, or other conventional input device.

In response to the detected occlusion, the system may effect a change in a virtual or physical system. For example, the command may control a user interface displayed on AR glasses or another wearable display, display additional information, allow selection of a movie or showtime, purchase movie tickets, order an item, turn on a light, move virtual controls, generate a command to a machine or apparatus, or send information to sensors, software, machines, or industrial systems. The system may provide feedback through a visual display, an auditory response from an AI assistant, haptic feedback, vibration, heat, scent, or another indication, but the printed surface can remain useful even when the responsive user interface or system action is not spatially attached to the printed surface. In this way, a known poster, panel, or plaque provides a low-compute, low-power, low-latency, and location-specific mechanism for generating user input commands through camera-based recognition and occlusion detection.

### 11.9. SUB-AREAS OF PATTERNS AND IMAGES

Sub-areas of patterns and images may include defined regions within a larger printed or displayed image, pattern, marker arrangement, icon set, QR code arrangement, ArUco marker row, button graphic, geometric feature, alphanumeric feature, or other computer-discernible arrangement of data. The sub-areas can be disposed on a physical object or surface, such as a poster, panel, plaque, book-like object, industrial control surface, tabletop, toy, yoga mat, instrument, or other tangible surface. Each sub-area may be known to the system by stored pattern data, reference image data, encoded data, location data within the larger image, or other information that enables the computer system to identify the sub-area in camera-captured image data.

A scanning device, such as a camera associated with AR-enabled glasses, a head-mounted display, a phone camera, an optical camera, a depth camera, a LiDAR camera, or another image-capture device, captures the larger pattern or image and the sub-areas contained therein. The computer system analyzes the captured data to recognize known images or patterns and determine the locations of one or more defined sub-areas on the physical surface. Recognition may include comparing the captured data with stored patterns or reference images. It may include the use of algorithms or machine-learning techniques trained to recognize and distinguish among multiple patterns, images, or image regions.

The defined sub-areas may function as interaction areas for generating user input commands. For example, a sub-area may correspond to an icon, a printed button, a “Yes” or “No” selection, an ArUco marker, a QR code, a visual control, or another known region of a printed poster, panel, plaque, or other surface. When a user touches, covers, or otherwise blocks a defined sub-area from the scanning device's view, the system detects occlusion of that known sub-area and interprets it as a user input command. In this manner, the system can use a localized change in visibility of a known image region as an input mechanism, rather than requiring a keyboard, mouse, controller, touch-sensitive panel, wearable input device, or complex hand-tracking analysis.

In response to occlusion of a known sub-area, the computer system may modify a virtual manifestation, control a user interface displayed on AR-enabled glasses or another display device, display additional information, select a movie or showtime, purchase tickets, move virtual controls, generate a command to a machine or apparatus, or send information to sensors, software, machines, or industrial systems. The sub-area may control content spatially related to the recognized physical surface, or control a detached user interface, non-visual interface, or physical system that is not physically bound to the detected image. Accordingly, known sub-areas of patterns and images provide a low-compute, low-power, low-latency, and geographically specific mechanism for converting physical interaction with a printed or recognizable surface into virtual or physical system commands.

### 11.10. GENERATING USER INPUT COMMANDS

Generating user input commands may be performed by a system that includes a camera or other sensor system and the stored knowledge of one or more images, patterns, or defined sub-areas. The camera captures data from a printed or otherwise recognizable physical surface, such as a poster, panel, plaque, book-like object, industrial control surface, tabletop, toy, yoga mat, instrument, or other tangible surface. The computer system analyzes the captured data stream to recognize a known image or pattern and to determine one or more interaction areas within the recognized image or pattern that are defined for occlusion detection.

After recognizing the image, pattern, or defined sub-area, the system can monitor the captured sensor data to detect an occlusion of a known interaction area. The occlusion may occur when a user touches, covers, or otherwise blocks the interaction area from the view of the camera or sensor system. Because the interaction area is known to the system, the detected localized change in visibility can be interpreted as a user input command without requiring a keyboard, mouse, controller, touch-sensitive panel, spoken command, wearable input device, or complex gesture-tracking analysis. The command may be generated for an attached virtual manifestation, a detached user interface, a non-visual interface, an internal system, or an external physical system.

In response to the generated user input command, the system may effect a change in a virtual or physical system. For example, the command may modify a virtual manifestation, control a user interface displayed on AR-enabled glasses or another display device, cause an AI assistant to register a user decision, select information, order an item, turn on a light, purchase tickets, move virtual controls, generate a command to a machine or apparatus, or send information to sensors, software, machines, or industrial systems. The system may provide feedback through visual, auditory, haptic, vibrational, thermal, scent, or other outputs. Still, the generation of the user input command can be based on camera-based recognition and occlusion detection, without requiring that the affected system action be spatially bound to the physical surface.

### 11.11. AI-BASED EXAMPLE IMPLEMENTATIONS

Currently, many commercially available smart glasses and wearable display devices include cameras and AI assistant functionality but still lack an efficient physical-world input mechanism. The closest analogous systems in virtual reality and augmented reality headsets typically rely on hand-tracking, gesture recognition, or AI-based interpretation of user movement. These approaches are technically complex because they require the system to continuously identify, track, and interpret variable human anatomy, motion, and intent.

The disclosed occlusion-detection approach provides a more direct and efficient way to trigger an event in response to a user action within an augmented reality environment. Rather than requiring an AI system to infer a command from complex hand motion or gesture patterns, the system can recognize a known image or pattern and determine whether a defined portion of that image or pattern has been touched, covered, or otherwise occluded by the user. This allows the system to generate an input command based on a relatively simple visual cue associated with a known physical target.

As a result, the system can reduce reliance on compute-intensive AI hand-tracking, surface-tracking, and gesture-recognition processes. Detecting a known image and detecting its occlusion can be significantly less computationally demanding than tracking hands, mapping surfaces, and interpreting probabilistic user gestures. This is particularly beneficial for AR headsets, smart glasses, and other wearable devices, where battery life, processing capacity, heat management, and real-time responsiveness are at a premium.

Presented herein, smart glasses and wearable display devices may include a camera and an AI assistant. The disclosed system can be configured to interact with such AI-assisted devices by providing the AI assistant with an indication that a printed pattern registered with the system is nearby. For example, the AI assistant may guide a user toward a corresponding physical object, such as a promotional poster, an information display, a control surface, or another interactive experience.

As the user approaches the printed pattern, the AI assistant may use camera-captured image data to provide context-dependent instructions based on recognition of the registered pattern. The AI assistant may instruct the user to touch, cover, select, or otherwise occlude particular portions of the printed pattern. Occlusion of a defined portion of the printed pattern may then generate an occlusion trigger that causes the system to perform an event, such as presenting content, modifying a displayed user interface, activating a promotion, initiating a transaction, controlling a virtual object, or triggering another computer-implemented response.

In some implementations, an onboard AI model, large language model, agent-based AI system, or other AI assistant may support implementation of the disclosed technology. The AI system may interpret pre-printed markup, printed images, visual codes, symbols, or other physical indicia that contain information readable from a camera feed. Based on the recognized printed indicia, the AI system may generate or modify user interfaces, virtual objects, instructions, prompts, or contextual displays associated with the physical surface.

The AI system may further generate context-dependent experiences based on information such as the user's location, proximity to the printed pattern, time of day, date, season, user history, environmental context, or content associated with the registered pattern. For example, the AI assistant may recognize a printed poster or other physical surface, determine that the surface is associated with a particular interactive experience, generate a user interface or virtual object for presentation on a wearable display, and instruct the user how to interact with the surface by occluding particular regions of the printed pattern.

This approach allows AI-generated or AI-supported content to be controlled via a deterministic, occlusion-based input mechanism. Rather than relying primarily on probabilistic gesture recognition, hand tracking, or voice interpretation, the AI system may use the recognized physical pattern as a contextual anchor and use occlusion of defined portions of that pattern as a reliable input signal. In this manner, AI assistance can enhance the disclosed interaction paradigm by generating contextual content and user guidance while the printed pattern and occlusion detection provide a low-power, low-latency, and geographically defined input mechanism.

### 11.12.EXAMPLE METHOD

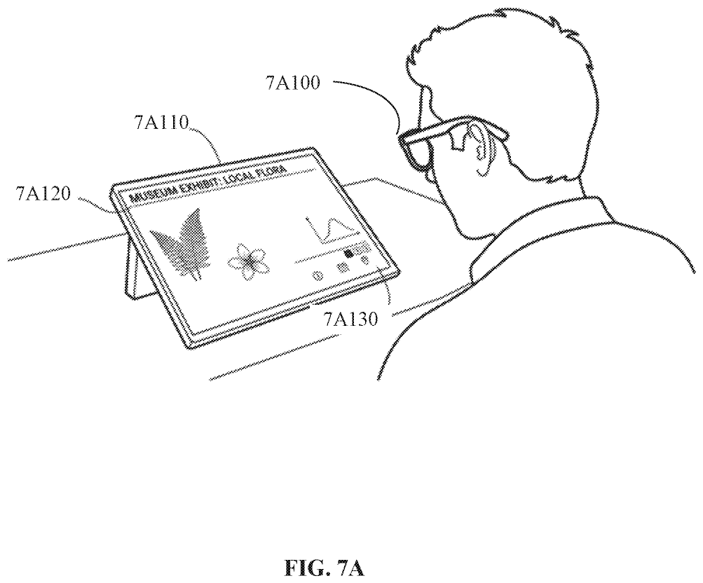

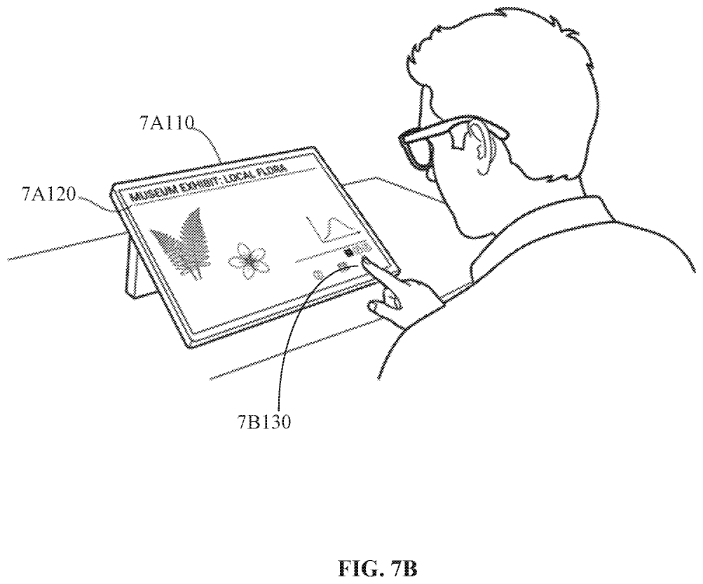

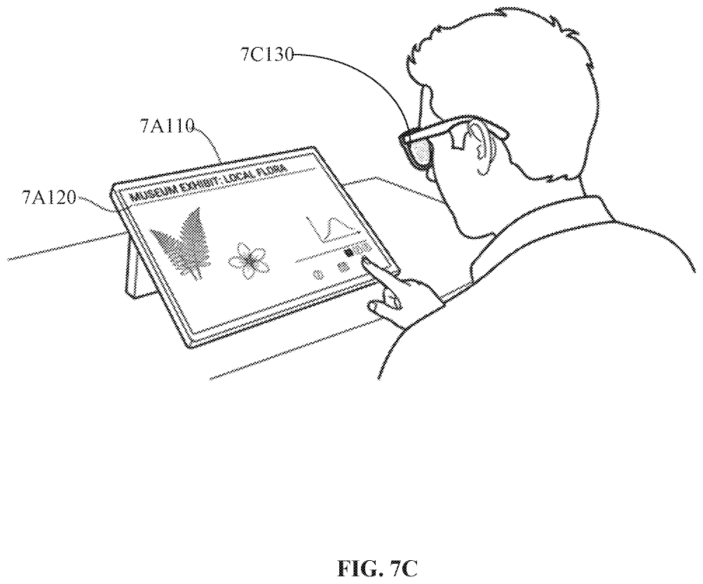

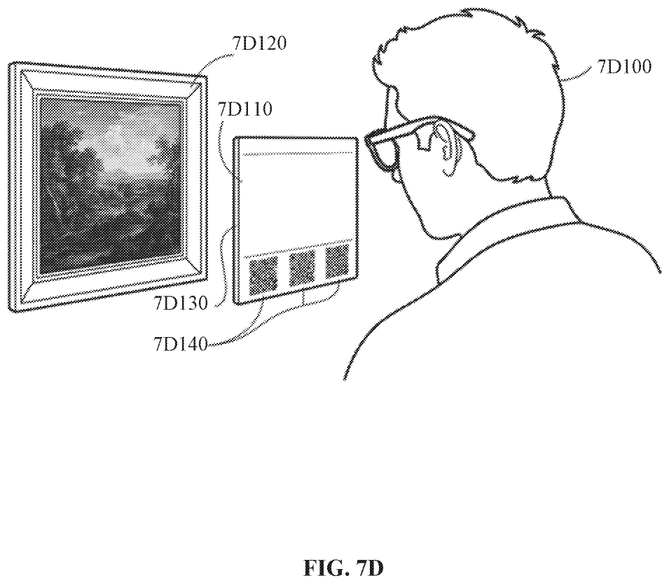

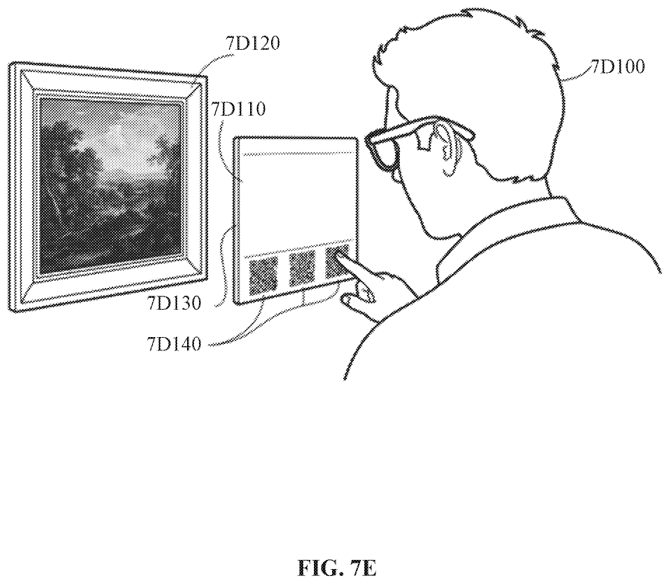

FIG. 7A is an example panel view showing a user wearing AR-enabled glasses 7A100 with a camera and display-capable lenses. In particular, FIG. 7A shows a user wearing AR-enabled glasses 7A100 with camera and display-capable lenses as the user approaches, for example, a panel 7A110 of the kind found in a museum or at a point of interest. The panel has a general information image 7A120 printed on its surface. In the lower-right corner of the panel print, there are distinct sub-portions 7A130 of the image composed of unique icons indicating information, a timeline, and a map.

FIG. 7B is an example panel touch showing an example user interaction with an image. As shown in FIG. 7B, to interact with the image, a user touches (occludes) 7B130 one of the icons 7B130 in the lower-right corner of the panel, which sends a user input command to the system to display additional information.

FIG. 7C is an example of a panel-touch HUD that displays additional information in a user interface 7C130. The additional information is displayed in a user interface 7C130 on the surface of the glasses, based on the user-generated input command, with the user occluding the specific location on the panel image.

FIG. 7D is an example of a plaque view that displays plaque information in a user interface. More specifically, FIG. 7D shows a user, 7D100, wearing AR-enabled glasses with a camera and display-capable lenses, approaching a plaque of the kind found in a museum. 7D110 is the plaque's printed surface. 7D120 is a static picture that could be found in a museum. 7D130 is the plaque, the kind typically used in a museum to display information about the picture. 7D140 is the QR code for a known interaction area.

FIG. 7E is an example of a plaque-touch that displays plaque information in a user interface. Plaque 7D120 is known to the system, and detection of the plaque in the AR glasses' visual sensor feed causes a user interface to appear in the glasses when the user approaches the plaque. The user touches the plaque to control the user interface on the AR glasses' display surface.

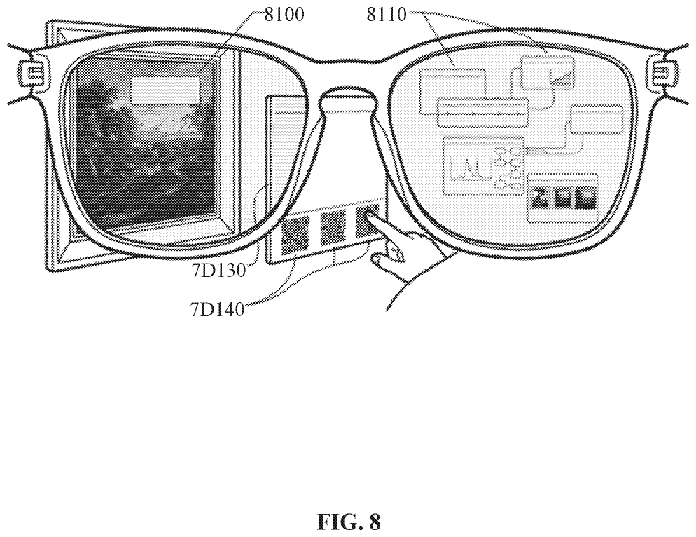

FIG. 8 is an example of a plaque touch HUD. Specifically, FIG. 8 shows a user interface in the AR glasses that the user controls, occluding the QR codes printed on the plaque's image. Based on image detection and occlusion, a user can control the user interface to display additional information 8110 relevant to the painting described by a plaque 8100.

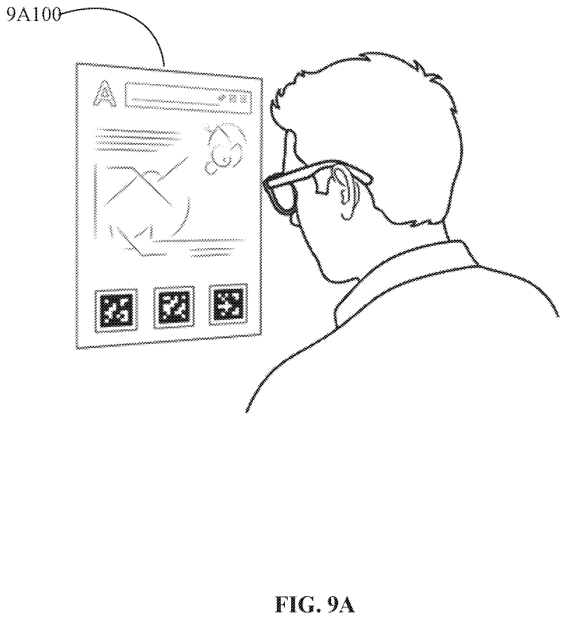

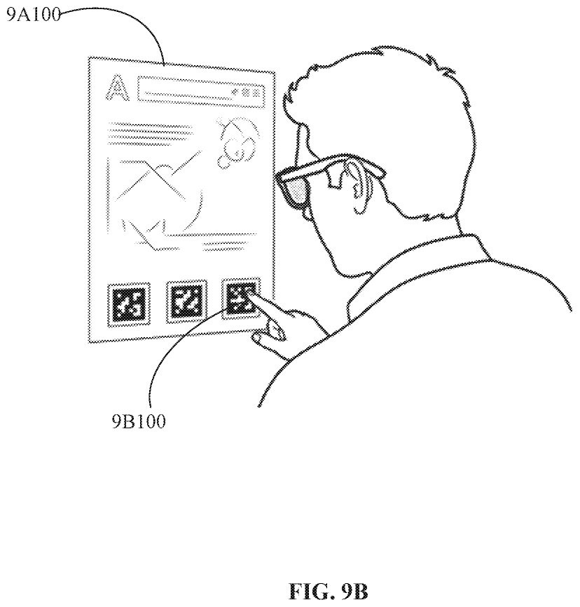

FIG. 9A is an example of a poster view. In particular, FIG. 9A shows a user wearing AR-enabled glasses with camera-and display-capable lenses, approaching a movie poster 9A100, like those found in movie theaters. The poster is an image of general movie poster art, information, and a row of ArUco markers along the bottom. The image and the sub-areas with the ArUco markers are known to the system.

FIG. 9B is an example of a poster touch. As the user approaches the movie poster, which is known to the system, the detection of the known image triggers the appearance of a user interface. The user interface appears on the AR glasses' display, indicating that controls are present on the poster. The user touches 9B100 on the poster to occlude an ArUco code, which generates a user input command and allows the user to interact with the user interface on the hardware's display surface to view showtimes and purchase movie tickets.

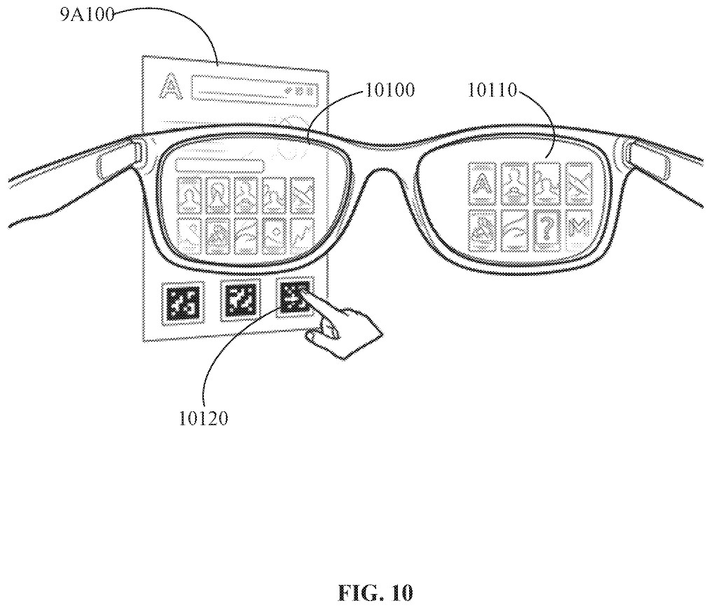

FIG. 10 is an example of a poster touch HUD. Specifically, FIG. 10 shows examples of user interfaces 10100 and 10110 that could appear on the display surface of the AR-glasses. The interface allows a user to select (10120) a movie and showtime, and purchase movie tickets, using occluding ArUco markers to generate user input commands that control the user interface displayed on the AR-glasses' display surface.

### 11.12.1. EXAMPLE FLOW

In some implementations, a computer-implemented method for pattern-based user interaction in virtual environments uses a registered printed image on a physical surface as a physically grounded input substrate for controlling a separate user interface, application, or physical device. An image sensor captures image data of the physical surface, and a computer system analyzes it to recognize the registered printed image. The registered printed image includes predefined interaction areas, which are mapped to their respective user input commands. The predefined interaction areas may correspond to printed indicia, visual controls, icons, markers, codes, geometric features, alphanumeric characters, symbols, image regions, or other visually identifiable portions of the printed image.

After recognizing the registered printed image, the computer system detects whether a user has locally occluded one of the predefined interaction areas. The localized occlusion may occur when the user touches, covers, or otherwise blocks the predefined interaction area from the image sensor's view. Because the occluded area is a known interaction region in the registered printed image, the computer system can determine which user input command is associated with it. It can generate the mapped user input command based on the detected localized occlusion.

In some implementations, the user input command is generated without determining a hand gesture corresponding to the command. For example, the computer system need not identify a hand pose, interpret a gesture class, or track the user's hand path to determine the intended command. Instead, the system may select the user-input command from a plurality of commands mapped to predefined interaction areas, based on which known interaction area is blocked by the image sensor. This allows the printed image to serve as a location-specific input surface while reducing reliance on gesture recognition or hand-tracking.

The physical surface carrying the registered printed image may be a poster, panel, plaque, sign, printed control surface, printed article, or another tangible surface. The registered printed image may include one or more codes, markers, icons, geometric patterns, alphanumeric characters, symbols, or registered image regions. In some implementations, the image sensor is integrated with a wearable display device, and a target user interface is presented on the wearable display device's display. The target user interface may be presented as a non-spatial interface within the wearable display device's field of view, rather than as an augmented reality overlay anchored to the printed image.

In response to the generated user input command, the computer system causes the generation and transmission of a response to a target user interface, application, or physical device. The target user interface, application, or physical device is separate from the physical surface and is not displayed as an augmented reality overlay anchored to the printed image. The response may control an application, initiate a transaction, select displayed content, control a machine, or control a physical device. Accordingly, the printed image may provide a physical, repeatable, and geographically specific input mechanism. At the same time, the resulting action may occur in a separate software interface, a wearable device display, an application environment, a machine control system, or a physical device.

In some implementations, an artificial intelligence assistant may generate an instruction to the user, contextual content, or the target user interface based on recognition of the registered printed image. The artificial intelligence assistant may use the recognized printed image as contextual information to determine which content, prompt, interface, or instruction to present to the user. The user-input command generated by localized occlusion of one of the predefined interaction areas may then control the AI-generated instruction, contextual content, or the target user interface. In this manner, AI-supported content generation may be combined with deterministic occlusion-based input, allowing the user to control contextual or AI-generated experiences by selectively occluding known areas of a registered printed image.

### 11.12.2. EXAMPLE FLOWCHART

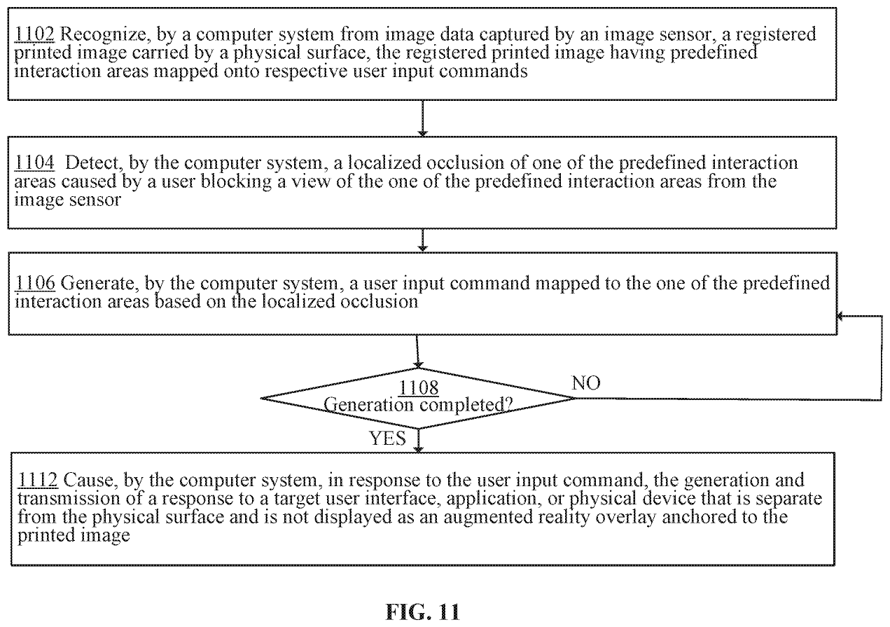

FIG. 11 shows an example method for pattern-based user interaction in virtual environments. At step 1102, a computer system recognizes, from image data captured by an image sensor, a registered printed image carried by a physical surface. The registered printed image has predefined interaction areas mapped onto respective user input commands. The registered printed image may comprise a code, marker, icon, geometric pattern, alphanumeric character, symbol, or image region registered in stored image information, and the physical surface may comprise a poster, panel, plaque, sign, printed control surface, printed article, or another tangible surface.

At step 1104, the computer system detects a localized occlusion of one of the predefined interaction areas. The localized occlusion is caused by a user blocking the view of one of the predefined interaction areas from the image sensor, such as by touching, covering, or otherwise obscuring it. Because the predefined interaction areas are mapped to their respective user input commands, the computer system can determine which predefined interaction area has been occluded without needing to identify a hand gesture corresponding to that command or track the user's hand path.

At step 1106, the computer system generates a user input command mapped to the one of the predefined interaction areas based on the localized occlusion.

At decision step 1108, the computer system determines whether generation of the user input command is complete. If generation has not been completed, the computer system may continue or repeat processing associated with generating the user input command. If generation has been completed, the method proceeds to step 1112.

At step 1112, the computer system, in response to the user input command, causes the generation and transmission of a response to a target user interface, application, or physical device. The target user interface, application, or physical device is separate from the physical surface and is not displayed as an augmented reality overlay anchored to the printed image. The response may comprise controlling an application, initiating a transaction, selecting displayed content, controlling a machine, or controlling a physical device.

In some implementations, the image sensor may be integrated with a wearable display device, and the target user interface may be presented on the wearable display device's display as a non-spatial user interface within the wearable display device's field of view.

In some implementations, an artificial intelligence assistant may generate, based on recognizing the registered printed image, at least one instruction to the user, contextual content, or the target user interface, and the user input command generated from the localized occlusion may control the at least one instruction, contextual content, or target user interface.

### 11.13.EXAMPLE SYSTEM

In some implementations, a system for pattern-based user interaction in virtual environments includes an image sensor, one or more processors, and one or more non-transitory computer-readable storage media storing instructions executable by the one or more processors. The image sensor is configured to capture image data depicting a registered printed image carried by a physical surface. The registered printed image includes predefined interaction areas mapped to corresponding user input commands, so that different portions of the printed image may serve as selectable input areas for the system.

The physical surface may include a poster, panel, plaque, sign, printed control surface, printed article, or another tangible surface carrying the registered printed image. The predefined interaction areas may include respective printed indicia that visually identify respective selectable inputs. The registered printed image may include a code, marker, icon, geometric pattern, alphanumeric character, symbol, image region, or other printed feature registered in stored image information accessible to the system.

When one or more processors execute the instructions, the system recognizes the registered printed image in the image data captured by the image sensor. Recognition of the registered printed image enables the system to determine the locations of predefined interaction areas relative to the image and associate them with the corresponding user input commands. The system then detects a localized occlusion in one of the predefined interaction areas when a user blocks that area's view from the image sensor. For example, the user may touch, cover, or otherwise obscure a particular predefined interaction area, and the system may identify the corresponding user input command based on the occluded location.

In some implementations, the system generates a user-input command mapped to the occluded predefined interaction area based on localized occlusion, without determining a hand gesture corresponding to the user-input command. The system may also select the user-input command from a plurality of commands mapped to predefined interaction areas without tracking the user's hand path. In this manner, the system may interpret selection of a known printed interaction area rather than relying on gesture classification, hand-pose estimation, or motion-path analysis.

In response to the user input command, the system generates and transmits a response to a target user interface, application, or physical device. The target user interface, application, or physical device is separate from the physical surface and is not displayed as an augmented reality overlay anchored to the printed image. Accordingly, the registered printed image may provide a physical input substrate. At the same time, the resulting response may be delivered to or performed by a separate software interface, application environment, machine, or physical device.

In some implementations, the image sensor is integrated with a wearable display device, and the target user interface is presented on the wearable display device's display. The target user interface may be presented as a non-spatial interface within the wearable display device's field of view, rather than as an augmented reality overlay fixed to the printed image's location. This allows the physical surface to serve as a convenient input mechanism while the displayed interface remains separate from and not spatially anchored to the physical surface.

In some implementations, when executed by one or more processors, the instructions further cause an artificial intelligence assistant to generate an instruction to the user, contextual content, or the target user interface based on recognition of the registered printed image. The user-input command generated from localized occlusion may control the instruction, contextual content, or the target user interface. Thus, the system may combine AI-generated contextual output with localized occlusion-based input so that user interaction with a registered printed image controls AI-supported content or interface functions.

### 11.14. BENEFITS OF THE PRESENT APPROACH

The disclosed system addresses the deficiencies of other systems through a robust, low-power, low-compute, low-latency system that uses image detection, occlusion detection, and physically printed images and patterns known to the system. The detection-and-occlusion paradigm provides an interaction method and input-signal generation mechanism that can operate efficiently on minimally resourced hardware without requiring computational tasks to be offloaded to larger cloud-based systems.

The system also provides alignment between the user and the physical world, thereby addressing a technical gap that limits the creation of geographically and temporally meaningful experiences in other systems. Whereas other systems tie interactions and input mechanisms to a user's physical body, the present system decouples input generation from the user's person. It anchors the input generation to panels, plaques, posters, and similar physical objects, thereby allowing interactions to be associated with specific physical objects and locations in the user's environment.

Another benefit of the present system is a one-to-one relationship between what is detected by the hardware visual system, such as a camera, depth sensor, or similar sensor, and what is represented in the real world as the interaction mechanism. In many current augmented reality systems, user input is generated by detecting a user's hands and interpreting hand activity in a camera feed, or by requiring the user to wear a bracelet or similar device that detects finger taps or other body-based actions. These input-analysis techniques use estimation as a foundational method and rely on analyzing inherently variable signals and objects, such as human hands, gestures, and motions. By contrast, the present system uses images known to the system and matches detected visual information to the corresponding image in the real world. This deterministic approach, rather than the probabilistic approach used by many current technologies, simplifies system architecture and improves efficiency and reliability.

According to the present approach, the user input system based on occlusion detection can generate user input commands that affect virtual manifestations having a direct spatial relationship to a printed pattern, as well as virtual manifestations that are part of the same sensor, data, and display system but are not physically bound to the image being detected. This decoupling of the control surface from the user interface is implicit throughout the parent specification and the previously filed continuation claims. This divisional application demonstrates that the allowed interaction method applies not only to immediate-feedback virtual manifestations but also to a novel signal-generation method in which interaction with a known physical image or pattern produces a user-input command for a separate virtual or physical response.

What is claimed is:

1. A computer-implemented method for pattern-based user interaction in virtual environments, the method comprising:
recognizing, by a computer system from image data captured by an image sensor, a registered printed image carried by a physical surface, the registered printed image having predefined interaction areas mapped onto respective user input commands;
detecting, by the computer system, a localized occlusion of one of the predefined interaction areas caused by a user blocking a view of the one of the predefined interaction areas from the image sensor;
generating, by the computer system, a user input command mapped to the one of the predefined interaction areas based on the localized occlusion; and
causing, by the computer system, in response to the user input command, the generation and transmission of a response to a target user interface, application, or physical device that is separate from the physical surface and is not displayed as an augmented reality overlay anchored to the printed image.

2. The method of claim 1, wherein generating, by the computer system, a user input command mapped to the one of the predefined interaction areas is performed without determining a hand gesture corresponding to the respective user input command.

3. The computer-implemented method of claim 1, wherein the physical surface comprises a poster, panel, plaque, sign, printed control surface, or printed article.

4. The computer-implemented method of claim 1, wherein the predefined interaction areas comprise respective printed indicia visually identifying respective selectable inputs.

5. The computer-implemented method of claim 1, wherein the registered printed image comprises at least one of a code, marker, icon, geometric pattern, alphanumeric character, symbol, or image region registered in the stored image information.

6. The computer-implemented method of claim 1, wherein the image sensor is integrated with a wearable display device, and wherein the target user interface is presented on a display of the wearable display device.

7. The computer-implemented method of claim 6, wherein the target user interface is presented as a non-spatial user interface within a field of view of the wearable display device.

8. The computer-implemented method of claim 1, wherein generating the respective user input command comprises selecting the respective user input command from a plurality of commands mapped to the predefined interaction areas without tracking a path of a user's hand.

9. The computer-implemented method of claim 1, wherein the response comprises controlling an application, initiating a transaction, selecting displayed content, controlling a machine, or controlling a physical device.

10. The computer-implemented method of claim 1, further comprising generating, by an artificial intelligence assistant based on recognizing the registered printed image, at least one instruction to the user, contextual content, or the target user interface, wherein the respective user input command generated from the localized occlusion controls the at least one of the instruction, contextual content, or target user interface.

11. A system for pattern-based user interaction in virtual environments, the system comprising:
an image sensor configured to capture image data depicting a registered printed image carried by a physical surface, the registered printed image having predefined interaction areas mapped to respective user input commands;
one or more processors; and
one or more non-transitory computer-readable storage media storing instructions that, when executed by the one or more processors, cause the system to:
recognize the registered printed image from the image data;
detect a localized occlusion of one of the predefined interaction areas caused by a user blocking a view of the one of the predefined interaction areas from the image sensor;
generate a user input command mapped to the one of the predefined interaction areas based on the localized occlusion; and
cause, by the computer system, in response to the user input command, the generation and transmission of a response to a target user interface, application, or physical device that is separate from the physical surface and is not displayed as an augmented reality overlay anchored to the printed image.

12. The system of claim 11, wherein generating the user input command mapped to one of the predefined interaction areas is performed without determining a hand gesture corresponding to the user input command.

13. The system of claim 11, wherein the physical surface comprises a poster, panel, plaque, sign, printed control surface, or printed article.

14. The system of claim 11, wherein the predefined interaction areas comprise respective printed indicia visually identifying respective selectable inputs.

15. The system of claim 11, wherein the registered printed image comprises at least one of a code, marker, icon, geometric pattern, alphanumeric character, symbol, or image region registered in stored image information.

16. The system of claim 11, wherein the image sensor is integrated with a wearable display device, and wherein the target user interface is presented on a display of the wearable display device.

17. The system of claim 16, wherein the target user interface is presented as a non-spatial user interface within a field of view of the wearable display device.

18. The system of claim 11, wherein generating the user input command comprises selecting the user input command from a plurality of commands mapped to the predefined interaction areas without tracking a path of a user's hand.

19. The system of claim 11, wherein the instructions, when executed by the one or more processors, further cause an artificial intelligence assistant to generate, based on recognition of the registered printed image, at least one instruction to the user, contextual content, or the target user interface, and wherein the user input command generated from the localized occlusion controls the at least one instruction, contextual content, or target user interface.

20. A non-transitory computer-readable medium storing instructions that, when executed by one or more processors of a computer system, cause the computer system to:
recognize, from image data captured by an image sensor, a registered printed image carried by a physical surface, the registered printed image having predefined interaction areas mapped to respective user input commands;
detect a localized occlusion of one of the predefined interaction areas caused by a user blocking a view of the one of the predefined interaction areas from the image sensor;
generate a user input command mapped to the one of the predefined interaction areas based on the localized occlusion without determining a hand gesture corresponding to the user input command; and
cause, by the computer system, in response to the user input command, the generation and transmission of a response to a target user interface, application, or physical device that is separate from the physical surface and is not displayed as an augmented reality overlay anchored to the printed image.
